(19) United States
(12) Patent Application Publication
(10) Pub. No.: US 2026/0303251 A1
(43) Pub. Date: Oct. 1, 2026

(54) CONSTELLATION DECOMPOSITION AND COMPOUND BIT-LEVEL AND SYMBOL-LEVEL PROBABILISTIC AMPLITUDE SHAPING

(71) Applicant: QUALCOMM Incorporated, San Diego, CA (US)

(72) Inventors: Wei LIU, Beijing (CN); Thomas Joseph RICHARDSON, South Orange, NJ (US); Changlong XU, Beijing (CN); Liangming WU, Beijing (CN); Jian LI, Shanghai (CN); Hao XU, Beijing (CN)

(21) Appl. No.: 19/476,082

(22) PCT Filed: Jun. 12, 2023
(86) PCT No.: PCT/CN2023/099598

§ 371 Date: Oct. 16, 2025

(51) Int. Cl. H04L 1/00; H04L 27/34

(52) U.S. Cl. CPC H04L 1/0003; H04L 27/3405

(57) ABSTRACT

Methods, systems, and devices for wireless communications are described, described techniques provide for performing multiple encoding and shaping operations in parallel. The device may perform shaping operations for smaller sets of symbols (e.g., smaller alphabets) from a constellation. The transmitting device may perform one or more shaping operations on each layer of multiple layers, each layer corresponding to one or more bit levels. The transmitting device may shape the top-most layer using an operation that applies to the entirety of the constellation symbols. However, the other layers include shaping operations that are applied to smaller subsets of the symbols (e.g., smaller alphabets). The transmitting device may determine which shaping operation is to be applied in these other layers based on the output of the top-most layer shaping operation.

### CROSS REFERENCE

The present application is a 371 national phase filing of International PCT Application No. PCT/CN2023/099598 by LIU et al., entitled “CONSTELLATION DECOMPOSITION AND COMPOUND BIT-LEVEL AND SYMBOL-LEVEL PROBABILISTIC AMPLITUDE SHAPING,” filed Jun. 12, 2023, which is assigned to the assignee hereof, and which is expressly incorporated by reference in its entirety herein.

### TECHNICAL FIELD

The following relates to wireless communications, including constellation decomposition and compound bit-level and symbol-level probabilistic amplitude shaping.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support constellation decomposition and compound bit-level and symbol-level probabilistic amplitude shaping. For example, the described techniques provide for a transmitting device, which may perform multiple encoding and shaping operations in parallel. In addition, some shaping operations may be conditional upon the results of other shaping operations. The resulting hierarchy of shaping operations may involve application of shaping operations for smaller sets of symbols (e.g., smaller alphabets) from the constellation, resulting in a less processing-intensive operation. To accomplish this, the information sequence may be organized into a series of rows and columns, where each row is defined as a bit level and each column corresponds to one of the constellation symbols. The bit levels may then be organized in layers of one or more levels. The transmitting device may perform one or more shaping operations on each layer. The transmitting device may shape the top-most layer using an operation that applies to the entirety of the row (all of the constellation symbols). However, the other layers include shaping operations that are applied to smaller subsets of the symbols (e.g., smaller alphabets). The transmitting device may determine which shaping operation is to be applied in these other layers based on the output of the top-most layer shaping operation. Because the different layers may involve more than one bit level, the shaping operations in a layer may be symbol-level (e.g., for layers with multiple levels) or bit-level (e.g., for layers with just one level). The use of these mixed and hierarchical shaping operations may place less processing burden on the transmitting device.

A method for wireless communications at a first wireless device is described. The method may include obtaining a data payload for transmission via a message, where the message is generated through a modulation constellation associated with a first quantity of constellation symbols, each of the first quantity of constellation symbols representative of a respective potential bit string of the data payload, generating a set of multiple bit streams through application of a set of multiple shaping operations to all or part of an actual bit string of the data payload, where one or more of the set of multiple shaping operations are applied to corresponding portions of the actual bit string such that respective bit streams of the set of multiple bit streams are associated with one or more second quantities of constellation symbols of the modulation constellation, where the one or more second quantities are less than the first quantity, modulating the actual bit string to a corresponding constellation symbol of the modulation constellation to generate the message, and transmitting the data payload via the message to a second wireless device.

An apparatus for wireless communications at a first wireless device is described. The apparatus may include at least one processor, at least one memory coupled with the at least one processor, and instructions stored in the at least one memory. The instructions may be executable by the at least one processor (e.g., directly, indirectly, after-processing, without pre-processing) to cause the apparatus to obtain a data payload for transmission via a message, where the message is generated through a modulation constellation associated with a first quantity of constellation symbols, each of the first quantity of constellation symbols representative of a respective potential bit string of the data payload, generate a set of multiple bit streams through application of a set of multiple shaping operations to all or part of an actual bit string of the data payload, where one or more of the set of multiple shaping operations are applied to corresponding portions of the actual bit string such that respective bit streams of the set of multiple bit streams are associated with one or more second quantities of constellation symbols of the modulation constellation, where the one or more second quantities are less than the first quantity, modulate the actual bit string to a corresponding constellation symbol of the modulation constellation to generate the message, and transmit the data payload via the message to a second wireless device.

Another apparatus for wireless communications at a first wireless device is described. The apparatus may include means for obtaining a data payload for transmission via a message, where the message is generated through a modulation constellation associated with a first quantity of constellation symbols, each of the first quantity of constellation symbols representative of a respective potential bit string of the data payload, means for generating a set of multiple bit streams through application of a set of multiple shaping operations to all or part of an actual bit string of the data payload, where one or more of the set of multiple shaping operations are applied to corresponding portions of the actual bit string such that respective bit streams of the set of multiple bit streams are associated with one or more second quantities of constellation symbols of the modulation constellation, where the one or more second quantities are less than the first quantity, means for modulating the actual bit string to a corresponding constellation symbol of the modulation constellation to generate the message, and means for transmitting the data payload via the message to a second wireless device.

A non-transitory computer-readable medium storing code for wireless communications at a first wireless device is described. The code may include instructions executable by a processor (e.g., directly, indirectly, after-processing, without pre-processing) to obtain a data payload for transmission via a message, where the message is generated through a modulation constellation associated with a first quantity of constellation symbols, each of the first quantity of constellation symbols representative of a respective potential bit string of the data payload, generate a set of multiple bit streams through application of a set of multiple shaping operations to all or part of an actual bit string of the data payload, where one or more of the set of multiple shaping operations are applied to corresponding portions of the actual bit string such that respective bit streams of the set of multiple bit streams are associated with one or more second quantities of constellation symbols of the modulation constellation, where the one or more second quantities are less than the first quantity, modulate the actual bit string to a corresponding constellation symbol of the modulation constellation to generate the message, and transmit the data payload via the message to a second wireless device.

In some examples of the method, apparatuses, and non-transitory computer-readable medium described herein, the corresponding constellation symbol of the modulation constellation may be indicated by at least a portion of the set of multiple bit streams, where the set of multiple bit streams may be organized into groups of bit streams, each group including one bit stream which contributes to the actual bit string of the corresponding constellation symbol of the modulation constellation.

In some examples of the method, apparatuses, and non-transitory computer-readable medium described herein, each group of bit streams corresponds to a respective bit layer having a width of one or more bits on which respective ones of the set of multiple shaping operations may be applied.

In some examples of the method, apparatuses, and non-transitory computer-readable medium described herein, a first shaping operation of the set of multiple shaping operations may be applied to a first bit layer of a set of multiple bit layers for the first quantity of constellation symbols and the one or more of the set of multiple shaping operations may be applied to one or more second bit layers of the set of multiple bit layers for the corresponding one or more second quantities of constellation symbols, each bit layer of the set of multiple bit layers corresponding to one or more bit levels that correspond to the respective width.

In some examples of the method, apparatuses, and non-transitory computer-readable medium described herein, the first shaping operation may be a bit level energy-based shaping operation and the one or more of the set of multiple shaping operations include one or more symbol-level energy-based shaping operations.

Some examples of the method, apparatuses, and non-transitory computer-readable medium described herein may further include operations, features, means, or instructions for inputting the actual bit string to the first shaping operation and outputting, from the first shaping operation, a first shaped bit stream of the set of multiple bit streams.

Some examples of the method, apparatuses, and non-transitory computer-readable medium described herein may further include operations, features, means, or instructions for inputting, to a first of the one or more of the set of multiple shaping operations, a first summary of the first shaping operation and a first portion of the actual bit string corresponding to a first of the one or more second bit layers, inputting, to a second of the one or more of the set of multiple shaping operations, a second summary of the first shaping operation and a second portion of the actual bit string corresponding to the first of the one or more second bit layers, where the first summary and the second summary each pertain to a respective bit value output by the first shaping operation, outputting, from the first of the one or more of the set of multiple shaping operations, a second shaped bit stream of the set of multiple bit streams, and outputting, from the second of the one or more of the set of multiple shaping operations, a third shaped bit stream of the set of multiple bit streams, where the second shaped bit stream and the third shaped bit stream may be both associated with a same bit layer.

In some examples of the method, apparatuses, and non-transitory computer-readable medium described herein, a width of each of the one or more second bit layers corresponds to a quantity of bit levels of a respective one of the one or more second bit layers.

In some examples of the method, apparatuses, and non-transitory computer-readable medium described herein, generating the set of multiple bit streams may include operations, features, means, or instructions for performing the first of the one or more of the set of multiple shaping operations and the second of the one or more of the set of multiple shaping operations in parallel.

In some examples of the method, apparatuses, and non-transitory computer-readable medium described herein, one or more of the set of multiple shaping operations may be based on a bit-layer shaping parameter including a bit-layer sequence composition corresponding to the actual bit string.

In some examples of the method, apparatuses, and non-transitory computer-readable medium described herein, one or more of the set of multiple shaping operations may be based on a constant composition distribution matching procedure corresponding to the second quantity of constellation symbols.

In some examples of the method, apparatuses, and non-transitory computer-readable medium described herein, generating the set of multiple bit streams may include operations, features, means, or instructions for performing one or more iterations of a first shaping operation and a second shaping operation of the set of multiple shaping operations, each iteration of the one or more iterations corresponding to a respective bit layer of a set of multiple bit layers.

Some examples of the method, apparatuses, and non-transitory computer-readable medium described herein may further include operations, features, means, or instructions for determining a shaping parameter for each iteration of the one or more iterations, the shaping parameter based on a threshold sequence energy, a bit-bit layer sequence energy parameter value, a decomposed alphabet for the second shaping operation, a threshold sequence length, or any combination thereof.

Some examples of the method, apparatuses, and non-transitory computer-readable medium described herein may further include operations, features, means, or instructions for incrementing an iteration counter after each of the one or more iterations, where the modulating may be based on the counter satisfying a threshold quantity of iterations.

Some examples of the method, apparatuses, and non-transitory computer-readable medium described herein may further include operations, features, means, or instructions for inputting, for each limitation of the one or more iterations subsequent to a first iteration of the one or more iterations, a first portion of the actual bit string, the first portion having a sequence length based on an output sequence of bits of a previous iteration of the one or more iterations.

Some examples of the method, apparatuses, and non-transitory computer-readable medium described herein may further include operations, features, means, or instructions for inputting, for the one or more iterations including a single iteration, the actual bit string.

In some examples of the method, apparatuses, and non-transitory computer-readable medium described herein, the modulating may include operations, features, means, or instructions for sequentially reading elements from the respective bit streams of the set of multiple bit streams based on an increasing order of bit layers from a first bit layer to a last bit layer of a set of multiple bit layers.

### BRIEF DESCRIPTION OF THE DRAWINGS

FIG. 1 shows an example of a wireless communications system that supports constellation decomposition and compound bit-level and symbol-level probabilistic amplitude shaping in accordance with one or more aspects of the present disclosure.

FIG. 2 shows an example of an encoding procedure that supports constellation decomposition and compound bit-level and symbol-level probabilistic amplitude shaping in accordance with one or more aspects of the present disclosure.

FIG. 3 shows an example of a constellation decomposition scheme that supports constellation decomposition and compound bit-level and symbol-level probabilistic amplitude shaping in accordance with one or more aspects of the present disclosure.

FIG. 4 shows an example of an encoding procedure that supports constellation decomposition and compound bit-level and symbol-level probabilistic amplitude shaping in accordance with one or more aspects of the present disclosure.

FIG. 5 shows an example of a constellation decomposition scheme that supports constellation decomposition and compound bit-level and symbol-level probabilistic amplitude shaping in accordance with one or more aspects of the present disclosure.

FIG. 6 shows an example of a encoding procedure that supports constellation decomposition and compound bit-level and symbol-level probabilistic amplitude shaping in accordance with one or more aspects of the present disclosure.

FIG. 7 shows an example of a constellation decomposition scheme that supports constellation decomposition and compound bit-level and symbol-level probabilistic amplitude shaping in accordance with one or more aspects of the present disclosure.

FIG. 8 shows an example of an encoding procedure that supports constellation decomposition and compound bit-level and symbol-level probabilistic amplitude shaping in accordance with one or more aspects of the present disclosure.

FIG. 9 shows an example of a constellation decomposition scheme that supports constellation decomposition and compound bit-level and symbol-level probabilistic amplitude shaping in accordance with one or more aspects of the present disclosure.

FIG. 10 shows an example of an encoding procedure that supports constellation decomposition and compound bit-level and symbol-level probabilistic amplitude shaping in accordance with one or more aspects of the present disclosure.

FIG. 11 shows an example of a process flow that supports constellation decomposition and compound bit-level and symbol-level probabilistic amplitude shaping in accordance with one or more aspects of the present disclosure.

FIGS. 12 and 13 show block diagrams of devices that support constellation decomposition and compound bit-level and symbol-level probabilistic amplitude shaping in accordance with one or more aspects of the present disclosure.

FIG. 14 shows a block diagram of a communications manager that supports constellation decomposition and compound bit-level and symbol-level probabilistic amplitude shaping in accordance with one or more aspects of the present disclosure.

FIG. 15 shows a diagram of a system including a UE that supports constellation decomposition and compound bit-level and symbol-level probabilistic amplitude shaping in accordance with one or more aspects of the present disclosure.

FIG. 16 shows a diagram of a system including a network entity that supports constellation decomposition and compound bit-level and symbol-level probabilistic amplitude shaping in accordance with one or more aspects of the present disclosure.

FIGS. 17 through 19 show flowcharts illustrating methods that support constellation decomposition and compound bit-level and symbol-level probabilistic amplitude shaping in accordance with one or more aspects of the present disclosure.

### DETAILED DESCRIPTION

One or more wireless devices may communicate with each other in a wireless communications system. For example, when a transmitting device (e.g., a user equipment (UE)) transmits in accordance with a specific modulation and coding scheme (MCS), the transmitted message is transmitted using a constellation of symbols. The distribution of content across the constellation of symbols may affect the reliability of the transmission. Some devices may perform probabilistic shaping to improve the distribution across the constellation. Probabilistic shaping may be performed to support a target distribution. Such target distributions may be reached by performing bit-level shaping (e.g., shaping on a bit-by-bit basis), or symbol-level shaping (e.g., shaping on a symbol-by-symbol basis, which may involve more than one bit). In either case, a shaping operation may be applied to a sequence of information bits to both shape and modulate the sequence so as to populate the constellation symbols. If a transmitting device applies the shaping operation on a full sequence in order to populate all of the symbols of the constellation, the transmitting device may experience a high processing cost. Therefore, methods for applying the shaping operation for fewer than all of the constellation symbols may result in a decrease processing cost at the transmitting device and improve reliability of wireless communications.

As described herein, the transmitting device may perform multiple shaping operations in parallel. In addition, some shaping operations may be conditional upon the results of other shaping operations. The resulting hierarchy of shaping operations may involve application of shaping operations for smaller sets of symbols from the constellation, resulting in a less processing-intensive operation. To accomplish this, the information sequence may be organized into a series of rows and columns, where each row is defined as a bit level and each column corresponds to one of the constellation symbols. The bit levels may then be organized in layers of one or more levels. The transmitting device may perform one or more shaping operations on each layer. The transmitting device may shape the top-most layer using an operation that applies to the entirety of the row (all of the constellation symbols). However, the other layers include shaping operations that are applied to smaller subsets of the symbols (e.g., smaller alphabets). The transmitting device may determine which shaping operation is to be applied in these other layers based on the output of the top-most layer shaping operation. Because the different layers may involve more than one bit level, the shaping operations in a layer may be symbol-level (e.g., for layers with multiple levels) or bit-level (e.g., for layers with just one level). The use of these mixed and hierarchical shaping operations may place less processing burden on the transmitting device.

Aspects of the disclosure are initially described in the context of wireless communications systems. Aspects of the disclosure are further illustrated by and described with reference to encoding procedures, constellation decomposition schemes, and process flows. Aspects of the disclosure are further illustrated by and described with reference to apparatus diagrams, system diagrams, and flowcharts that relate to constellation decomposition and compound bit-level and symbol-level probabilistic amplitude shaping.

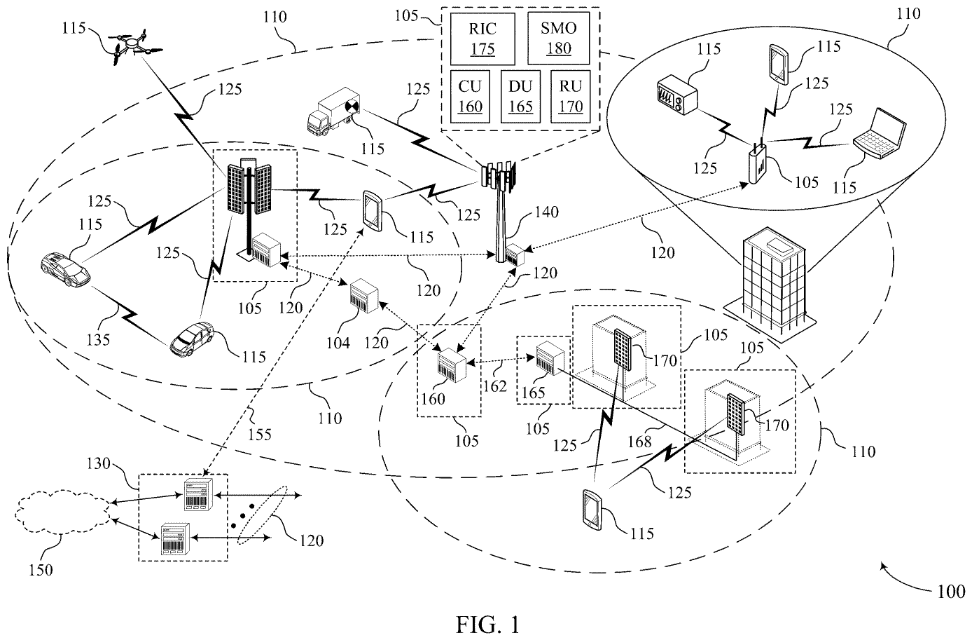

FIG. 1 shows an example of a wireless communications system 100 that supports constellation decomposition and compound bit-level and symbol-level probabilistic amplitude shaping in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support constellation decomposition and compound bit-level and symbol-level probabilistic amplitude shaping as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a personal computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

As described herein, the transmitting device may perform multiple shaping operations in parallel. In addition, some shaping operations may be conditional upon the results of other shaping operations. The resulting hierarchy of shaping operations may involve application of shaping operations for smaller sets of symbols from the constellation, resulting in a less processing-intensive operation. To accomplish this, the information sequence may be organized into a series of rows and columns, where each row is defined as a bit level and each column corresponds to one of the constellation symbols. The bit levels may then be organized in layers of one or more levels. The transmitting device may perform one or more shaping operations on each layer. The transmitting device may shape the top-most layer using an operation that applies to the entirety of the row (all of the constellation symbols). However, the other layers include shaping operations that are applied to smaller subsets of the symbols (e.g., smaller alphabets). The transmitting device may determine which shaping operation is to be applied in these other layers based on the output of the top-most layer shaping operation. Because the different layers may involve more than one bit level, the shaping operations in a layer may be symbol-level (e.g., for layers with multiple levels) or bit-level (e.g., for layers with just one level). The use of these mixed and hierarchical shaping operations may place less processing burden on the transmitting device.

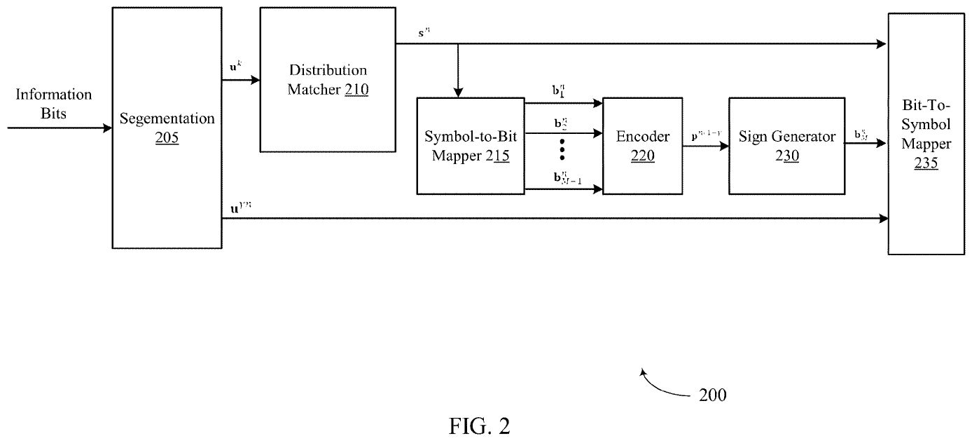

FIG. 2 shows an example of an encoding procedure 200 that supports constellation decomposition and compound bit-level and symbol-level probabilistic amplitude shaping in accordance with one or more aspects of the present disclosure. In some examples, encoding procedure 200 may be implemented by aspects of wireless communications system 100. For example, a transmitting device may encode a message for transmission to a receiving device according to encoding procedure 200. In some examples, the receiving device may perform a decoding operation including inverse operations corresponding to the operations of encoding procedure 200.

In some wireless communications systems, wireless devices may support one or more higher-order MCSs (e.g., QAM-16, QAM-64, and QAM-256), which may increase throughput. Constellations in such systems may be fixed, and each constellation point may be used with equal probability. In some examples (e.g., over an AQGN channel), such capacity may be achievable if an input distribution is a Gaussian distribution. However, the difference between a signal-to-noise (SNR) to achieve a rate with a given MCS and the SNR at which an improved capacity-achieving scheme could operate at the same rate may be referred to as a shaping gap. For such channels (e.g., QWGN channels), the shaping gap may be asymptotically equal to a threshold (e.g., about 1.53 dB) when channel inputs are uniformly distributed. Some constellation shaping techniques may reduce or lose the shaping gap, such as geometric shaping and probabilistic shaping. Geometric shaping may implement equiprobable signaling with Gaussian-like distributed constellation points, and probabilistic shaping may induce a non-uniform (e.g., Gaussian-like) distribution over constellation points. Probabilistic shaping may include trellis shaping and shell mapping, among other examples, In some examples, probabilistic amplitude shaping (PAS) may include shaping techniques for performing probabilistic shaping.

In some examples, a transmitting device may encode a set of bits (e.g., a TB or a CB), then transmit corresponding modulation symbols to a receiving device. The quantity of bits included in the set of bits may be represented as k+γn, where k may represent the quantity of bits within a first subset of the bits and γn may represent the quantity of bits within a second subset of the bits. The k bits in the first subset may be subjected to distribution matching (e.g., may be referred to as shaped bits, or alternatively referred to as amplitude bits), and the γn bits in the second subset may not be subjected to distribution matching (e.g., may be referred to as unshaped bits, or alternatively referred to as sign bits).

The transmitting device may input information bits into the segmentation 205, which may output a sequence u^{k} (e.g., u₁, u₂, . . . uₖ) including the k information bits. The distribution matcher 210 may input the sequence u^{k} and output a sequence sⁿ including n amplitude symbols (e.g., s₁, s₂, . . . sₙ. The distribution matcher 210 may apply a rate of R_{dm}=k/n and may encode the k information bits to n amplitude symbols. The distribution matcher 210 may be a constant-composition distribution matcher (CCDM), a multiset-partition distribution matcher (MPDM), or may use sphere shaping, among other possible distribution matching techniques. Based on a non-uniform probability distribution associated with (e.g., used by) the distribution matcher 210, different interim symbols within a pool of possible (e.g., candidate) interim symbols may not be equally likely to be included in the n-length sequence of interim symbols—that is, some interim symbols may be more likely to be included than others. In some cases, the interim symbols may be ASK symbols.

The distribution matcher 210 may output the sequence s″ into a symbol-to-bit mapper 215. The symbol-to-bit mapper 215 may convert the interim symbols into an (M−1) bit sequence of length n denoted by

$${b}_{1}^{n} , {b}_{2}^{n} … {b}_{M - 1}^{n} .$$

Each of the n amplitude symbols may correspond to (MM+1) bits, which respectively contribute one bit to the bit sequnces. These in total may result in n (M−1) amplitude bits, where m is a modulation order of the interim symbols (e.g., the quantity of different interim symbols within the pool of possible interim symbols may be equal to (M−1)).

In some examples, the transmitting device may input the n (M−1)-length bit sequence output by the symbol-to-bit mapper 215 and the γn unshaped bits to an FEC encoder 220. The FEC encoder 220 may support error correction for the subsequent transmission based on encoding redundancy into the transmission. Based on the bits input to the FEC encoder 220, the FEC encoder 220 may generate systematic bits and parity bits. For example, for every (m−1+γ) input bits, the FEC encoder 220 may generate m bits, where the extra bits may be parity bits. Thus, in some examples, the rate of encoding at the FEC encoder 220 may be calculated as

$${Rate}_{F E C} = \frac{m - 1 + γ}{m} .$$

In some cases, the transmitting device may determine γ based on the RateFEC. The FEC encoder 220 may generate (n(1−γ)) parity bits p^{n(1-γ)}. The n(1-γ) parity bits together with the γn extra information bits may be converted to a sign-bit sequence

$${b}_{M}^{n}$$

over {−1,1} by the sign generator 230. The n sign bits in the sequence

$${b}_{M}^{n}$$

may be pointwise multiplied with the n amplitude symbols in the sequence sⁿ. Sequence

$${b}_{M}^{n}$$

may be input to a bit-to-symbol mapper 235.

In some examples, as illustrated with reference to FIG. 2, a transmitter chain may perform the encoding procedure 200, and may perform symbol-level PAS. For example, such a transmitter chain may consider amplitude shifting keying (ASK) constellations with modulation order 2^{M}. An ASK constellation may consists of constellation points (e.g., ±1, ±3, ±5, . . . , ±(2^{M}−1)×{±1, ±3, ±5 . . . ±(2^{M}−1)} with an amplitude alphabet {1, 3, 5, . . . 2^{M}−1}. As described herein, an amplitude alphabet may refer to a set of constellation points for a bit string or bit sequence. For instance, for an MCS of QAM-256, an amplitude alphabet may refer to 2 a bit string of 8 bits to be applied to each candidate constellation point of 256 constellation points.

In some examples, symbol-level PAS methods may experience some increased processing costs. For example, for higher-order modulations, one or more values of an alphabet size m may be used, and may be greater than 1. For instance, or QAM-64, m=4, and for QAM-256, m=8. Symbol-level probabilistic shaping schemes may involve techniques that result in a computational complexity that increases with respect to m per iteration. Such methods for determining may therefore depend on m. Such techniques may result in larger computational complexity, an increase in latency based on symbol-level probabilistic shaping, or may result in an increase in memory and storage for symbol-level probabilistic shaping, among other examples.

In some examples, bit-level PAS methods may also experience some increased processing costs. For example, parallel bit-level probabilistic shaping methods may approach a product of binary distributions (e.g., distributions over {0,1}). The resulting symbol-level distribution corresponding to the product of binary distributions exhibit some small discrepancy compared with an underlying symbol-level target distribution. Such techniques may ignore capturing statistical dependences across different bit levels in return of a parallelization. Hierarchical bit-level probabilistic shaping methods may approach an underlying target symbol-level distribution. Some techniques may rely on performing multiple bit-level shaping operations in a sequential manner, which may result in increased latency. Such increased latency from sequential bit-level PAS methods or symbol-level PAS methods may be increased in cases of higher order MCS, such as QM-1024 or QAM-4096.

In some examples, as described herein, the transmitting device may perform multiple shaping operations in parallel. In addition, some shaping operations may be conditional upon the results of other shaping operations. The resulting hierarchy of shaping operations may involve application of shaping operations for smaller sets of symbols from the constellation, resulting in a less processing-intensive operation. To accomplish this, the information sequence may be organized into a series of rows and columns, where each row is defined as a bit level and each column corresponds to one of the constellation symbols. The bit levels may then be organized in layers of one or more levels. The transmitting device may perform one or more shaping operations on each layer. The transmitting device may shape the top-most layer using an operation that applies to the entirety of the row (all of the constellation symbols). However, the other layers include shaping operations that are applied to smaller subsets of the symbols (e.g., smaller alphabets). The transmitting device may determine which shaping operation is to be applied in these other layers based on the output of the top-most layer shaping operation. Because the different layers may involve more than one bit level, the shaping operations in a layer may be symbol-level (e.g., for layers with multiple levels) or bit-level (e.g., for layers with just one level). The use of these mixed and hierarchical shaping operations may place less processing burden on the transmitting device.

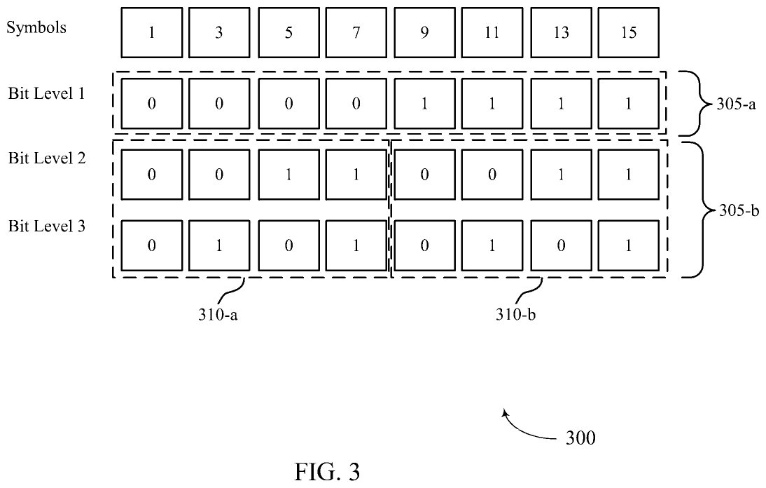

FIG. 3 shows an example of a constellation decomposition scheme 300 that supports constellation decomposition and compound bit-level and symbol-level probabilistic amplitude shaping in accordance with one or more aspects of the present disclosure. The constellation decomposition scheme 300 may be implemented by, or may implement aspects of, the wireless communications system 100, the encoding procedure 200, or both. For example, a transmitting device, which may an example of a corresponding devices described with reference to FIGS. 1-2 (e.g., a UE 115 or network entity 105), may perform probabilistic shaping and transmission based thereon according to the constellation decomposition scheme 300.

As described herein (e.g., with reference to FIG. 2), a transmitting device may perform probabilistic shaping with reference to a target distribution (e.g., a symbol-level target distribution, or a product of bit-level target conditional distributions). In a bit to symbol mapping, each symbol may map to one or more bits of a bit stream (b).

For instance, in an illustrative example described with reference to FIG. 3, symbol 1 may map to a bit stream of 000, symbol 3 may map to a bit stream of 001, symbol 5 may map to a bit stream of 010, and so forth. A given bits-to-symbol mapping may be based on (e.g., generated according to) one or more procedures such as natural labeling, Gray labeling, one-to-one mapping, among other examples. For a symbol α, ∈ [symbol] , (e.g., an alphabet [symbol] , bit streams b (e.g., b₁, b₁, . . . b_{M-1}) may represent a strong if 0s and 1s corresponding to symbol α (e.g., α=1, the bit stream is 0, 0, 0) according to the bits-to-symbol mapping. A target probability p(a) may be defined as

$$p ( a ) = {\prod }_{t = 1}^{M - 1} p ( {b}_{t} \vert {b}_{t - 1} , ... , {b}_{1} ) .$$

The symbol-level target distribution may thus induce multiple bit-level target conditional distributions, and a symbol-level target distribution can be written as a product of the bit-level target conditional distributions. Therefore, approaching a symbol-level target distribution may be realized by approaching each one of the bit-level target conditional distributions.

In some examples, as described herein, the transmitting device may divide, combine, or subdivide various bit levels into bit layers, allowing for simultaneous energy-level shaping using smaller alphabets. For instance, a constellation decomposition may be performed via conditioning procedures. Bit levels (e.g., values of b in the bit streams mapped to each symbol) may be grouped into various bit layers, which may correspond to different bit widths and smaller alphabets, resulting in decreased processing by the transmitting device. A transmitting device may perform a first encoding procedure (e.g., evaluation) to determine a constellation point for mapping a given bit string on a first subset of bits (e.g., a first layer such as layer 1). Based on the first encoding procedure, the transmitting device may perform one or more additional encoding procedures or additional layers 305 corresponding to larger bit widths. However, based on the first encoding procedure, subsequent encoding procedures may consume decreased processing resources at the transmitting device based on the smaller alphabets. For instance, for QAM-256, the transmitting device may evaluate the first bit (e.g., bit level 1) across a full alphabet (e.g., of 256 constellation points). However, for subsequent encoding procedures, the transmitting device may evaluate one or more additional bits of the bit string across a smaller alphabet (e.g., each of two bits across 64 constellation points for QAM-64 for bit layer 305-b). Encoding procedures applied for bit layer 305-b (e.g., for segment 310-a and segment 310-b of the bit layer 305-b) may be faster and more efficiently than performing encoding procedures for each bit of the bit string across the full alphabet (e.g., across the full 256 constellation points).

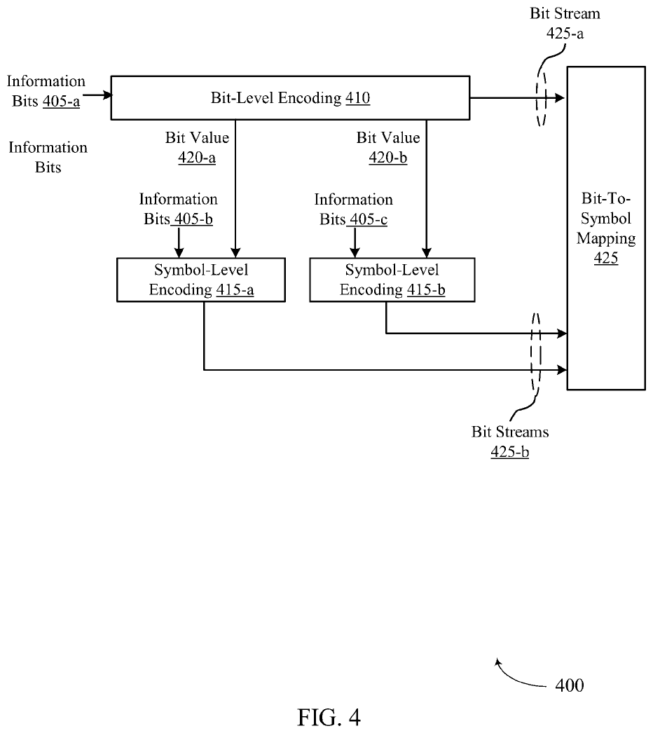

In such examples, the bit level 1 (e.g., having a bit width 1) may be included in a first bit layer 305-a. The bit layer 305-b may include a portion of bit level 2 and a portion of bit level 3 (e.g., bit width 2). For example, some conditioning methods may include factorizing a symbol-level probability distribution. For a symbol α, ∈ [symbol] , let (b₁, b₂, . . . , b_{M-1}), a probability p(a)=p(b₁)p(b₂, . . . , b_{M-1}|b₁), where p(a) refers to a symbol belonging to a smaller alphabet. For example, the transmitting device may simplify a shaping procedure by performing a first evaluation for each constellation point of a total quantity of constellation points (e.g., QAM-256 amplitudes) for a full alphabet (e.g., a first shaping procedure as described with reference to FIG. 4) for a first bit b. Based on the first evaluation, the transmitting device may perform one or more additional encoding procedures to evaluate subsequent bits of each bit string. For instance, for the bit layer 305-b, the transmitting device may perform a second encoding procedure using the reduced alphabet (e.g., for the segment 310-a), and may perform a third encoding procedure using a similarly reduced alphabet (e.g., for the segment 310-b). In such examples, the transmitting device may perform bit-level shaping to the first bit layer 305-a, and may perform two separate symbol-level shaping procedures for the bit layer 305-b (e.g., a first symbol-level shaping procedure for the segment 310-a and a second symbol-level shaping procedure for the segment 310-b).

Other combinations of encoding and shaping procedures may also be possible according to techniques described herein. For instance, the probability p(a)=p(b₁, b₂)p(b₃, . . . , b_{M-1}|b₁, b₂), which may give rise to different schemes. In some examples, the encoding and shaping schemes may include mixing various symbol-level encodings and shaping, or may include multiple (e.g., more than two) factors (e.g., multiple sets or subsets of layers).

FIG. 4 shows an example of an encoding procedure 400 that supports constellation decomposition and compound bit-level and symbol-level probabilistic amplitude shaping in accordance with one or more aspects of the present disclosure. In some examples, encoding procedure 400 may be implemented by aspects of wireless communications system 100, encoding procedure 200, constellation decomposition scheme 300, or any combination thereof. For example, a wireless device may encode a message for transmission to a receiving device according to encoding procedure 400. In some examples, the receiving device may perform a decoding operation including inverse operations corresponding to the operations of encoding procedure 400. Encoding procedure 400 may include aspects of an encoding operation.

In some examples, the transmitting device may perform various energy-based encoding and shaping procedures across different bit layers, where at least some of the encoding procedures correspond to reduced alphabets based on the bit widths of the bit layers (e.g., bit layers 305). For example, the information bits 405 (e.g., a sequence u^{k}, where u^{k}=(u₁, u₂, . . . , uₖ) and where k represents information bits). The transmitting device may perform a first encoding procedure (e.g., the bit-level encoding 410) on a first bit layer (e.g., bit layer 305-a, including bit level 1). For instance, the transmitting device may perform a first evaluation for a first bit n of the information bits 405-a across a full alphabet (e.g., across each of 256 constellation points for QAM-256) to determine a constellation point via which to transmit the information bits 405-a (e.g., a codeword, a bit string, a set of bits, among other examples). The bit-level encoding 410 may be performed on a first sequence of bits (e.g., bit layer 305-a including bit level 1 as described with reference to FIG. 3).

The transmitting device may perform on or more additional encoding operations (e.g., symbol-level energy-based encoding operations, including symbol-level encoding 415-a and symbol-level encoding 415-b. The transmitting device may perform the encoding operations (e.g., the symbol-level encodings 415) on each respective sequence of bits. For instance, transmitting device may provide, as inputs to the symbol-level encodings 415, information bits 405, one or more bit values 420, or a combination thereof. For instance, the bit-level encoding 410 may be applied to a first bit (e.g., bit level 1) of a bit string. The first bit n of the bit string (e.g., bit layer 305-a) may be a 1 or a 0. Thus, the first segment 310-a of the bit layer 305-b may correspond to a first a bit value 420-a (e.g., where the first bit of the bit stream is 0, which may be referred to as n_{2, 0}), while the second segment 310-b of the bit layer 305-b may correspond to a second bit value 420-b (e.g., where the first bit of the bit stream is 1, which may be referred to as n_{2, 1}). In such examples, the information bits 405-b may refer to remaining bits of the bit stream corresponding to the bit value 420-a (e.g., information bits u^{k}^{_{2,0}} for n_{2, 0}) and the information bits 405-c may refer to remaining bits of the bit stream corresponding to the bit value 420-b (e.g., information bits u^{k}^{_{2,1}} for n_{2, 1}). Thus, the symbol-level encoding 415-a may be performed for a smaller alphabet than a total alphabet based on the bit-level encoding 410 performed for the first bit n, and the symbol-level encoding 415-b may be performed for a smaller alphabet than a total alphabet based on the bit-level encoding 410 performed for the smaller alphabet than the total alphabet based on the bit-level encoding 410 performed for the first bit n. In such examples, the transmitting device may perform the first encoding operation for a full alphabet (e.g., 256 constellation points) for the bit-level encoding 410, but may perform one or more additional encoding operations (e.g., symbol-level encodings 415) for a smaller alphabet (e.g., 64 constellation points for each of the first segment 310-a of the bit layer 305-b and the second segment 310-b of the bit layer 305-b based on having divided the total alphabet in half based on the bit-level encoding 410 resulting in either a 1 or a 0 for the first bit of the bit string).

In some examples, multiple encoding operations (e.g., the symbol-level encodings 415) may be performed in parallel, resulting in reduced encoding time, reduced latency, and improved throughput. For example, the transmitting device may perform the encodings for multiple bits (e.g., all bits or all but a subset of bits encoded in a first encoding procedure) at a symbol-level, instead of at a bit-level.

The bit-level encoding 410 may generate (e.g., output) one or more bit streams 425-a. The bit stream 425-a may include a bit sequence of bⁿ^{₁}=(1, 0, 0, 1, . . . ) based on the bit-level encoding 410 (e.g., corresponding to the bit layer 305-a). The quantity of bit streams for one bit-level encoding 410 may be equal to 2⁰=1 bit stream 425-a. Similarly, the symbol-level encodings 415 may generate one or more bit streams 425-b (e.g., for two symbol-level encodings 415, n₁=0. The bit streams 425-b may include one or more sequences sⁿ for n amplitude symbols. The quantity of bit streams for two symbol-level encodings 415 may be equal to 2¹=2. For instance, the symbol-level encoding 415-a may generate the sequence sⁿ^{_{2, 0}} for the bit value 420-a and information bits 405-b, where the sequence sⁿ^{_{2,0}}=(1, 1, 3, 5, . . . ), and the symbol-level encoding 415-b may generate the sequence sⁿ^{_{2,1}}=(5, 3, 3, 1, . . . ). The transmitting device may then perform bit-to-symbol mapping 425 according to the bit-level encoding 410 and the symbol-level encodings 415.

Techniques described herein may be performed with reference to any quantity of bit levels, in any quantity of bit layers (e.g., each bit layer corresponding to at least a portion of one or more bit levels). Encoding procedures may be performed (e.g., in parallel) on one or more alphabets, where at least some of the alphabets may be smaller (e.g., decomposed). For instance, a constellation may include an alphabet [symbol] (e.g., an alphabet [symbol] =256 for QAM-256. The alphabet [symbol] ={a₁, a₂, . . . , aₘ} consists of amplitude symbols of the constellation. The alphabet size m may be defined by 2 to the power of a positive integer (e.g., m may be a power of 2 and may be greater than 1). For instance, the alphabet size m may be one half of 2^{M} for an ASK constellation of order 2^{M}, or may be one half of the square root of 2^{M} for a QAM constellation of order 2^{2M}. In such examples, each aᵢ of the alphabet [symbol] may be defined as aᵢ=2i−1, where 1≤i≥m such that a₁=1, a₂=3, . . . , aₘ=2^{M}−1.

A bits-to-symbol mapping [symbol] for the alphabet [symbol] may be defined as [symbol] : {0, 1}^{M-1}→ [symbol] . [symbol] may be mapped as a binary expansion of i−1 to a respective amplitude symbol 2i−1 in [symbol] , where 1≤i≤m. The binary expansion may correspond to an element in {0, 1}^{M-1}. The notation b=(b₁, b₂, . . . , b_{M-1})∈{0, 1}^{M-1} may denote a vector of length M−1.

The alphabet [symbol] may be associated with L bit layers (e.g., any quantity of bit layers, such as 3 bit layers described with reference to FIGS. 3 and 4). L may be a positive integer larger than 1 and smaller than M−1 (e.g., there may be less bit layers than bit levels, each layer of the L bit layers may correspond to one or more bit levels). Each bit layer of the L bit layers may be associated with a respective positive integer, which may be referred to as a bit width. For example, a bit layer l of the L bit layers for l=1, 2, . . . , L may have a bit width of Bₗ. The sum of all involved bit widths B₁, B₂, . . . , B_{L} may be equal to M−1, such that

$${\sum }_{l = 1}^{L} {B}_{l} = M - 1.$$

In some examples, b may be defined as b_{B1}, b_{B}_{₂}, . . . , b_{B}_{_{L}}, where b_{B}_{₁}∈{0, 1}^{B}^{ₗ} for each l∈{1, 2, . . . , L}.

The transmitting device may support decomposed alphabets and decomposed bit-to-symbol mapping according to techniques described herein. [symbol] and [symbol] may induce L decomposed alphabets and L decomposed bits-to-symbol mappings. The decomposed alphabets may be denoted by [symbol] _{,1}, [symbol] _{, 2}, . . . , [symbol] _{,L}. Each decomposed alphabet may correspond to a respective bit layer l. [symbol] _{, l} may correspond to a bit layer l for l∈{1, 2, . . . , L}. Each decomposed alphabet has a respective cardinality that is 2 to the power of a respective positive integer. [symbol] _{, l} may have a cardinality equal to 2^{B}^{ₗ}, for l∈{1, 2, . . . , L}. Elements of [symbol] _{, l} are of the form 2i−1, with i∈{1, 2, . . . , 2^{B}^{ₗ}}.

The decomposed bits-to-symbol mappings, each of which is one-to-one are denoted by [symbol] ₁, [symbol] ₂, . . . , [symbol] _{L}. Each decomposed bits-to-symbol mapping may correspond to a respective bit layer. [symbol] ₗ may correspond to a bit layer l, for l∈{1, 2, . . . , L}. The domain of [symbol] ₗ may be {0, 1}^{B}^{ₗ}, and a range of [symbol] ₗ may be the decomposed alphabet [symbol] _{, l}. [symbol] ₗ may map a binary expansion of i−1 to a respective amplitude symbol 2i−1 in [symbol] _{, l}, where 1≤i≤2^{B}^{ₗ}. The transmitting device may perform a factorization of a target symbol-level probability distribution. For a∈ [symbol] with [symbol] (b)=a, where b=(b_{B}_{₁}, b_{B}_{₂}, . . . , b_{B}_{_{L}}) in accordance with L bit layers having respective bit widths of B₁, B₂, . . . , B_{L}. In such examples, a probability p (a) may be factorized as

$$p ( a ) = {\prod }_{l = 1}^{L} p ( {b}_{{B}_{l}} \vert {b}_{{B}_{l - 1}} , ... , {b}_{{B}_{1}} ) .$$

In some examples, the transmitting device may perform compound bit-level and symbol-level shaping procedures (e.g., PAS). Such shaping techniques may consist of L sequential steps. The shaping may be performed based on an alphabet [symbol] ={a₁, a₂, . . . , aₘ} having an alphabet size m and a sequence length n and a shaping parameter v. In some examples, the alphabet, alphabet size, sequence length, and shaping parameter may be configured (e.g., by the network). The shaping parameter v may be associated with a distribution (e.g., a Maxwell-Boltzmann distribution) over the alphabet [symbol] . Each step of the shaping may include one or more bit-level or symbol-level encoding operations (e.g., as described herein). Such encoding operations of each step (e.g., of a multi-step shaping operation) may be performed in parallel.

Shaping techniques may include one or more iterations. In some examples, a quantity of iterations of the shaping techniques may include L iterations, initializing at l=1 and iterating until l=L. Step l may correspond to bit layer l, and step l may include one or more encoding operations. The multiple encoding operations for step 1 may be equal to where

$${2}^{{\sum }_{j = 1}^{l - 1} {B}_{j}} ,$$

where 2^{Ø}=0 when l=1. Each encoding operation for step 1 may be associated with a respective index of the form {l, (b_{B}_{₁}, b_{B}_{₂}, . . . , b_{B}_{ₗ₋₁})}.

Each encoding operation for step 1 may obtain a respective sequence length. When l=1, the respective sequence length may be equal to the sequence length n, which is also denoted by n_{1,Ø}. When l>1, the respective sequence length may depend on a respective output sequence from previous steps l−1. An encoding operation with index {l, (b_{B}_{₁}, b_{B}_{₂}, . . . , b_{B}_{ₗ₋₁})} may obtain an output of

$${n}_{l , {b}_{{B}_{1}} , {b}_{{B}_{2}} , ... , {b}_{{B}_{l - 1}}} .$$

Each encoding operation may determine a respective bit layer shaping parameter based on a respective sequence length and the shaping parameter v. In some examples, the respective bit=layer shaping parameter v may be a bit layer sequence energy value (e.g., a threshold or maximum bit layer sequence energy). In such example, an encoding operation with index {l, (b_{B}_{₁}, b_{B}_{₂}, . . . , b_{B}_{ₗ₋₁})} may obtain

$${\overline{E}}_{l ,} ( {b}_{{B}_{1}} , {b}_{{B}_{2}} , … , {b}_{{B}_{l - 1}} ) .$$

In some examples, the respective bit layer shaping parameter is a bit layer sequence composition. In such examples, an encoding operation with index {l, (b_{B}_{₁}, b_{B}_{₂}, . . . , b_{B}_{ₗ₋₁})} may determine

$${k}_{l , ( {b}_{{B}_{1}} , {b}_{{B}_{2}} , ... , {b}_{{B}_{l - 1}} )} .$$

Each encoding operation for step I may determine a respective information bit sequence length. In some examples, an encoding operation with an index {l, (b_{B}_{₁}, b_{B}_{₂}, . . . , b_{B}_{ₗ₋₁})} may determine

$${k}_{l , ( {b}_{{B}_{1}} , {b}_{{B}_{2}} , ... , {b}_{{B}_{l - 1}} )} ,$$

such that

$${k}_{l , ( {b}_{{B}_{1}} , {b}_{{B}_{2}} , ... , {b}_{{B}_{l - 1}} )} \leq {log}_{2} {N}_{c}^{[ \vert {𝒜}_{m , l} \vert ]} ( {n}_{l , {b}_{{B}_{1}} , {b}_{{B}_{2}} , ... , {b}_{{B}_{l - 1}}} , {\overline{E}}_{l , ( {b}_{{B}_{1}} , {b}_{{B}_{2}} , ... , {b}_{{B}_{l - 1}} )} ) ,$$

where

$${N}_{c}^{[ m ]}$$

(n, [symbol] denotes a total quantity of sequences over [symbol] and having length n, each sequence with an energy less than or equal to [symbol] . In some examples, an encoding operation with index {l, (b_{B}_{₁}, b_{B}_{₂}, . . . , b_{B}_{ₗ₋₁})} may determine

$${k}_{l , ( {b}_{{B}_{1}} , {b}_{{B}_{2}} , ... , {b}_{{B}_{l - 1}} )}$$

such that

$${k}_{l , ( {b}_{{B}_{1}} , {b}_{{B}_{2}} , ... , {b}_{{B}_{l - 1}} )}$$

is less than or equal to log₂ of a multinomial coefficient (e.g.,

$$( e . g . , {k}_{l , ( {b}_{{B}_{1}} , {b}_{{B}_{2}} , ... , {b}_{{B}_{l - 1}} )} \leq {log}_{2} ( \begin{matrix}{n}_{l , {b}_{{B}_{1}} , {b}_{{B}_{2}} , ... , {b}_{{B}_{l - 1}}} \\ {k}_{l , ( {b}_{{B}_{1}} , {b}_{{B}_{2}} , ... , {b}_{{B}_{l - 1}} )}\end{matrix} ) ) .$$

In such examples, the determination of

$${k}_{l , ( {b}_{{B}_{1}} , {b}_{{B}_{2}} , ... , {b}_{{B}_{l - 1}} )}$$

may be based on

$${n}_{l , {b}_{{B}_{1}} , {b}_{{B}_{2}} , ... , {b}_{{B}_{l - 1}}}$$

and at least one of

$${\overline{E}}_{l , ( {b}_{{B}_{1}} , {b}_{{B}_{2}} , ... , {b}_{{B}_{l - 1}} )} or {k}_{l , ( {b}_{{B}_{1}} , {b}_{{B}_{2}} , ... , {b}_{{B}_{l - 1}} )} .$$

Each encoding operation for step l may obtain a respective sequence of information bits having the respective information bit sequence length. Each encoding operation may include encoding the respective sequence of information bits to a respective output sequence of bits. Techniques for performing each encoding operation may include energy-based shaping techniques based on a decomposed alphabet

$${𝒜}_{m , l} , {n}_{l , {b}_{{B}_{1}} , {b}_{{B}_{2}} , ... , {b}_{{B}_{l - 1}}} and {\overline{E}}_{l , ( {b}_{{B}_{1}} , {b}_{{B}_{2}} , ... , {b}_{{B}_{l - 1}} )} .$$

The energy-based shaping method may include arithmetic coding (AC) techniques, or energy-based peeling techniques, among other examples. In some examples, the encoding operations may include CCDM techniques based on

$${𝒜}_{m , l} , {n}_{l , {b}_{{B}_{1}} , {b}_{{B}_{2}} , ... , {b}_{{B}_{l - 1}}} and {k}_{l , ( {b}_{{B}_{1}} , {b}_{{B}_{2}} , ... , {b}_{{B}_{l - 1}} )} .$$

The output sequence generated by the encoding operation of index {l, (b_{B}_{₁}, b_{B}_{₂}, . . . , b_{B}_{ₗ₋₁})} may be denoted by

$${s}^{{n}_{l , {b}_{{B}_{1}} , {b}_{{B}_{2}} , ... , {b}_{{B}_{l - 1}}}} .$$

In some examples, the energy of the output sequence may be less than or equal to

$${\overline{E}}_{l , ( {b}_{{B}_{1}} , {b}_{{B}_{2}} , ... , {b}_{{B}_{l - 1}} )} .$$

In some examples, the composition of the output sequence may be equal to

$${k}_{l , ( {b}_{{B}_{1}} , {b}_{{B}_{2}} , ... , {b}_{{B}_{l - 1}} )} .$$

In some examples, the output sequence may have a length equal to

$${n}_{l , {b}_{{B}_{1}} , {b}_{{B}_{2}} , ... , {b}_{{B}_{l - 1}}} .$$

Each encoding operation for step l may determine a total number of as of the respective output sequence of bits for each a∈ [symbol] _{,l}. The encoding operation with index {l, (b_{B}_{₁}, b_{B}_{₂}, . . . , b_{B}_{ₗ₋₁})} may determine

$${n}_{l , {b}_{{B}_{1}} , {b}_{{B}_{2}} , ... , {b}_{{B}_{l - 1}} , {ℱ}_{l}^{- 1} ( a )}$$

for each ∈ [symbol] _{,l}, where

$${ℱ}_{l}^{- 1} ( a )$$

represents a pre-image of an under mapping [symbol] , which may be an element in {0, 1}^{B}^{ₗ}.

Having completed the encoding operation of step l, the transmitting device may increment l by 1, and may perform an additional iteration of the encoding operation until L iterations have been completed.

Having completed one or more iterations of the encoding operations, the transmitting device may perform bit-to-symbol mapping operations (e.g., the bit-to-symbol mapping 235). The bit-to-symbol mapping operation may be performed based at least in part on the output sequences and the bits-to-symbol mapping [symbol] . There may be a total of n bits-to-symbol mapping operations. For each operation, the transmitting deice may sequentially read off one element from a respective output sequence that corresponds to a respective bit layer. The sequential reading off may be performed from bit layer 1 to bit layer L. For example, the transmitting device may read off one element from sⁿ^{_{1,Ø}} and may denote the element as e₁. For l ranges from 2 to L, the transmitting device may read off one element from the output sequence

$${s}^{{n}_{l , {ℱ}_{1}^{- 1} ( {e}_{1} ) , {ℱ}_{2}^{- 1} ( {e}_{2} ) , ... , {ℱ}_{l - 1}^{- 1} ( {e}_{l - 1} )}} .$$

and denote the read off element by eₗ. The transmitting device may map

$${ℱ}_{1}^{- 1} ( {e}_{1} ) , {ℱ}_{2}^{- 1} ( {e}_{2} ) , ... , {ℱ}_{L}^{- 1} ( {e}_{L} ) .$$

to a symbol in the alphabet [symbol] according to the bits-to-symbol mapping [symbol] . The symbol may thus be obtained by

$$ℱ ( {ℱ}_{1}^{- 1} ( {e}_{1} ) , {ℱ}_{2}^{- 1} ( {e}_{2} ) , ... , {ℱ}_{L}^{- 1} ( {e}_{L} ) ) .$$

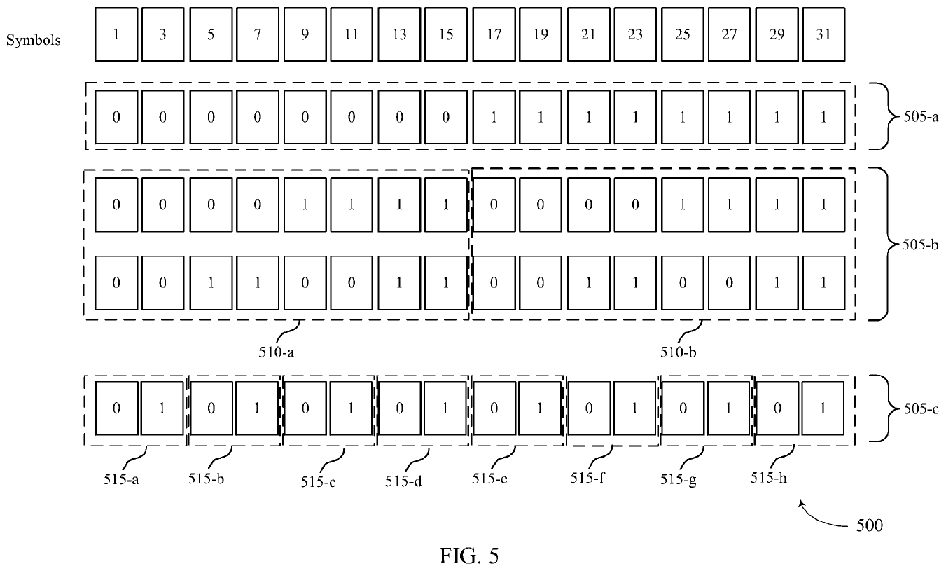

Decomposed, or smaller, alphabets utilized in additional encoding procedures (e.g., the symbol-level encodings 415, which may be performed in parallel) and shaping procedures as described herein may decrease a quantity of processing resources used for encoding a bit string (e.g., a data payload such as the information bits 405). Such techniques may result in improved throughout and decreased latency. A quantity of bit layers L may be different, as may the encoding procedures (e.g., a first encoding may be symbol-level encoding, and the additional encoding procedures may be bit-level encodings, performed in parallel, among other examples). Additional non-limiting examples are described with reference to FIGS. 5-11.

FIG. 5 shows an example of a constellation decomposition scheme 500 that supports constellation decomposition and compound bit-level and symbol-level probabilistic amplitude shaping in accordance with one or more aspects of the present disclosure. In some examples, the constellation decomposition scheme 500 may implement aspects of, or be implemented by aspects of, the wireless communications system 100, encoding procedure 200, constellation decomposition scheme 300, the encoding procedure 400, or any combination thereof. For example, a wireless device may encode a message for transmission to a receiving device according to the constellation decomposition scheme 500. In some examples, the receiving device may perform a decoding operation including inverse operations corresponding to the operations of constellation decomposition scheme 500.

In some examples, the wireless device may perform encoding, shaping, and bits-to-symbol mapping operations as described herein. In some examples, as illustrated with reference to FIG. 5, such procedures may be performed based on an alphabet [symbol] of size m (e.g., [symbol] ) where m=16, a quantity of layers L may be L=3, with 3 bit width B₁, B₂, and B₃. For example, bit layer 505-a may have a first bit width of B₁=1, bit layer 505-b may have a second bit width of B₂=2, and bit layer 505-c may have a bid width of B₃=1. The wireless device may identify a decomposed alphabet [symbol] _{16,1}={1, 3} for bit layer 505-a, a decomposed alphabet [symbol] _{16,2}={1, 3, 5, 7} for the bit layer 505-b, and a decomposed alphabet [symbol] _{16,1}={1, 3} for the bit layer 505-c. Each amplitude symbol a₂∈ [symbol] ₁₆ may correspond to a binary expansion. Such a binary expansion for, for example, symbol 3, may be written as (0, 0, 0, 1), where the first zero corresponds to b₁, the second zero and third zero correspond to b₂, and the four value (e.g., the 1) correspond to b₃.

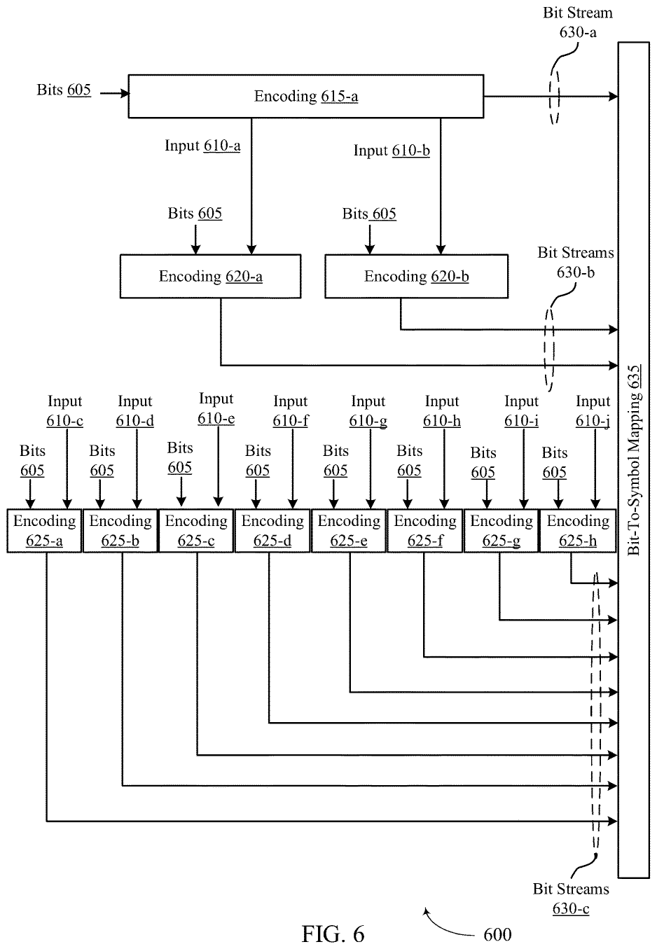

The first decomposed alphabet [symbol] _{16,1}={1, 3} may apply to the first bit layer 505-a (e.g., the first bit of the bit string may be 0, or 1). The wireless device may perform a first encoding procedure (e.g., across the full alphabet or the decomposed alphabet [symbol] _{16,1}={1, 3}) for the first bit layer 505-a. The second decomposed alphabet [symbol] _{16,2}={1, 3, 5, 7} may apply to the second bit layer 505-b, with a bit width of B₂=2. The decomposed alphabet [symbol] _{16,2} may define two bits (e.g., for each symbol) in the first segment 510-a of the bit layer 505-b, and may define two bits in the second segment 510-b of the bit layer 505-b. The wireless device may perform additional encoding procedures for the first segment 510-a and the second segment 510-b of the bit layer 505-b according to the decomposed alphabet [symbol] _{16,2}. The decomposed alphabet [symbol] _{16,1}={1, 3} may define a final bit (e.g., for each symbol) as a 1 or a 0 for the bit layer 505-c. Each segment 515 of the bit layer 505-c may define a final bit in a bit string as a 0 or a 1 for an identical prior portion of the bit string (e.g., 0000 or 0001 for symbol 1 and symbol 3, respectively, or 0010 or 0011 for symbol 5 and symbol 7, respectively). The decomposed alphabet [symbol] _{16,1}={1, 3} may therefore apply to segment 515-a, segment 515-b, segment 515-c, segment 515-d, segment 515-e, segment 515-f, segment 515-g, and segment 515-h of the bit layer 505-c. The wireless device may perform additional encoding procedures for one or more of the segments 515 according to the decomposed alphabet [symbol] _{16,3}. Such encoding procedures, shaping procedures, and bits-to-symbol mapping are described in greater detail with reference to FIG. 6.

FIG. 6 shows an example of an encoding procedure 600 that supports constellation decomposition and compound bit-level and symbol-level probabilistic amplitude shaping in accordance with one or more aspects of the present disclosure. The encoding procedure 600 may implement aspects of, or be implemented by aspects of, the wireless communications system 100, encoding procedure 200, constellation decomposition scheme 300, the encoding procedure 400, the constellation decomposition scheme 500, or any combination thereof. For example, a wireless device may encode a message for transmission to a receiving device according to the encoding procedure 600. In some examples, the receiving device may perform a decoding operation including inverse operations corresponding to the operations of encoding procedure 600.

The wireless device may perform one or more encoding procedures for a bit string (e.g., including one or more bits of a payload, such as u^{k}^{₁}. The wireless device may perform encoding 615-a on a first bit layer (e.g., bit layer 505-a). The encoding 615-a may include a bit-level CCDM procedure. The encoding 615-a may output a quantity of bit streams 630-a (e.g., 2⁰=1 bit streams including bⁿ^{₁}). The wireless device may perform one or more additional encoding procedures (e.g., encoding 620-a for segment 510-a of the bit layer 505-b and encoding 620-b for segment 510-b of the bit layer 505-b). The encodings 620 may be examples of symbol-level CCDM encoding procedures. The encoding 620-a may be based on an input of bits 605 (e.g., a remainder of the bit string u^{k}^{_{2,0}} for the first bit of the bit string set to 0) and an input 610-a which may be a sequence (e.g., n_{2, 0}), and the encoding 620-b may be based on an input of bits 605 (e.g., a remainder of the bit string u^{k}^{_{2,1}} for the first bit of the bit string set to 1) and an input 610-b which may be a sequence (e.g., n_{2, 1}). The encoding 620-a may output a first bit stream 630-b based on the sequence sⁿ^{_{2,0}} and the encoding 620-b may output a second bit stream 630-b based on the sequence sⁿ^{_{2,1}}. The encodings 620 may output a quantity 2⁰⁺¹=2 bit streams 630-b.

The wireless device may perform one or more encoding procedures for a bit string (e.g., including one or more bits of a payload, such as u^{k}^{₂}). The wireless device may perform encodings 625 on various segments 515 of the bit layer 505-c. The encodings 625 may include bit-level CCDM procedures. The encodings 625 may output a quantity of bit streams 630-c (e.g., 2¹⁺²=8 bit streams). Each encoding 625 may receive, as an input, bits 605 (e.g., u^{k}^{₃}), and inputs 610 (e.g., sequences based on the outputs of the encoding 615 and the encodings 620. For example, the encoding 625-a may apply to a final bit of a bit string, based on input 610-c (e.g., n_{3, 000}, corresponding to the first three bits of bit layer 505-a and bit layer 505-b). The encoding 625-b may apply to a final bit of the bit string, based on input 610-d (e.g., n_{3, 001}, corresponding to the first three bits of bit layer 505-a and bit layer 505-b in symbols 1 and 3). The encoding 625-c may apply to a final bit of the bit string, based on input 610-e (e.g., n_{3, 010}, corresponding to the first three bits of bit layer 505-a and bit layer 505-b in symbols 5 and 7). Similarly, the input 610-f for the encoding 625-d may be n_{3, 011}, the input 610-g for the encoding 625-e may be n_{3, 100}, the input 610-h for the encoding 625-f may be n_{3, 101}, the input 610-i for the encoding 625-g may be n_{3, 110}, and the input 610-j for the encoding 625-h may be n_{3, 111}.

The wireless device may perform bit-to-symbol mapping 635 based on the bit streams 630 (e.g., as described in greater detail with reference to FIG. 4).

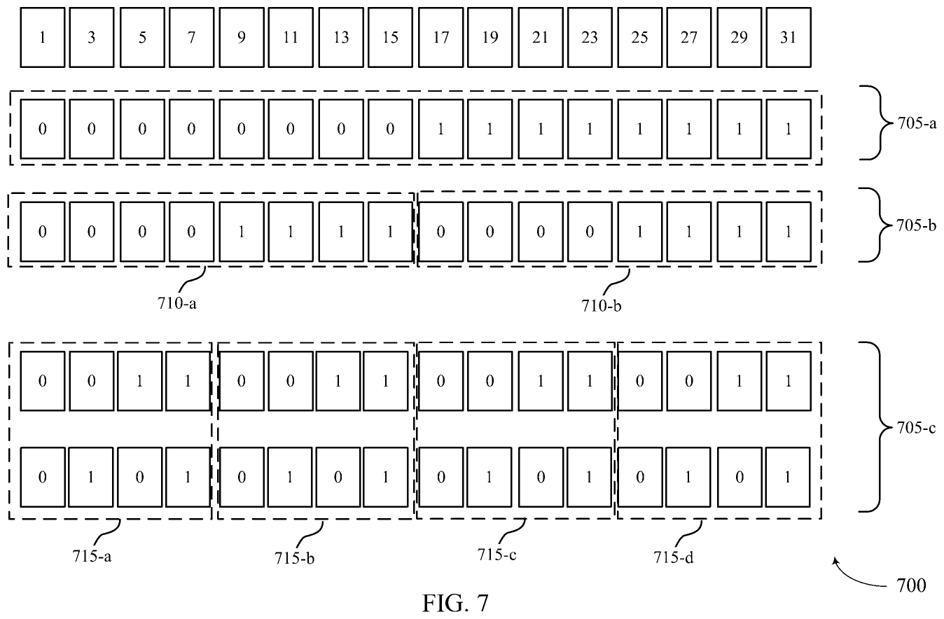

FIG. 7 shows an example of a constellation decomposition scheme 700 that supports constellation decomposition and compound bit-level and symbol-level probabilistic amplitude shaping in accordance with one or more aspects of the present disclosure. In some examples, the constellation decomposition scheme 700 may implement aspects of, or be implemented by aspects of, the wireless communications system 100, encoding procedure 200, constellation decomposition scheme 300, the encoding procedure 400, a constellation decomposition scheme 500, an encoding procedures 600, or any combination thereof. For example, a wireless device may encode a message for transmission to a receiving device according to the constellation decomposition scheme 700. In some examples, the receiving device may perform a decoding operation including inverse operations corresponding to the operations of constellation decomposition scheme 700.

In some examples, the wireless device may perform encoding, shaping, and bits-to-symbol mapping operations as described herein. In some examples, as illustrated with reference to FIG. 7, such procedures may be performed based on an alphabet [symbol] of size m (e.g., [symbol] ) where m=16, a quantity of layers L may be L=3, with 3 bit width B₁, B₂, and B₃. For example, bit layer 705-a may have a first bit width of B₁=1, bit layer 705-b may have a second bit width of B₂=1, and bit layer 705-c may have a bit width of B₃=2. The wireless device may identify a decomposed alphabet [symbol] _{16,1}={1, 3} for bit layer 705-a, a decomposed alphabet [symbol] _{16,2}={1, 3} for the bit layer 705-b, and a decomposed alphabet [symbol] _{16,1}={1,3, 5, 7} for the bit layer 705-c. Each amplitude symbol a₂ ∈ [symbol] ₁₆ may correspond to a binary expansion. Such a binary expansion for, for example, symbol 3, may be written as (0, 0,0,1), where the first zero corresponds to b₁, the second zero corresponds to b₂, and the third and fourth values (e.g., 0, 1) correspond to b₃.

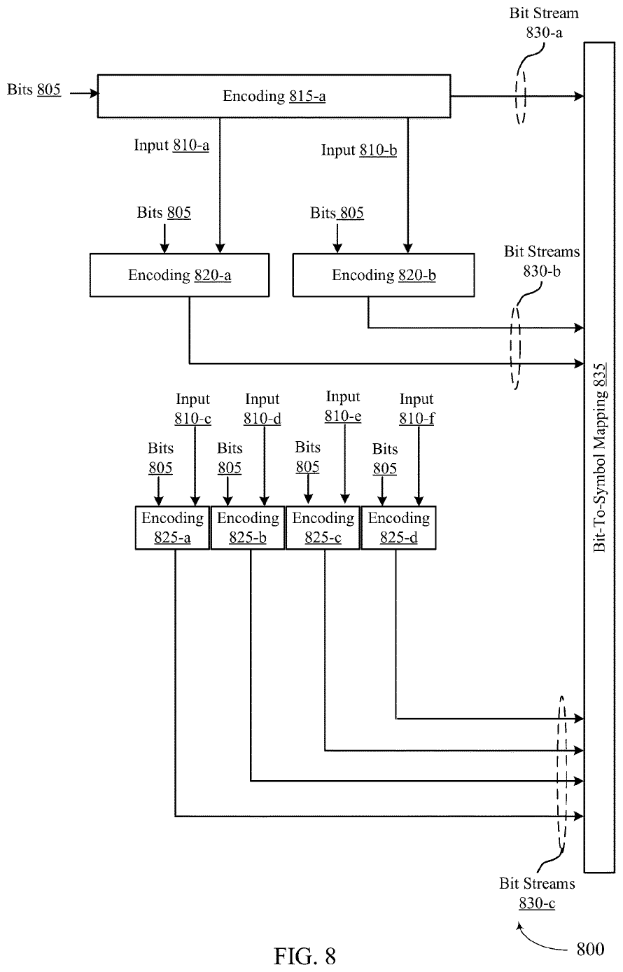

The first decomposed alphabet [symbol] _{16,1}={1, 3} may apply to the first bit layer 705-a (e.g., the first bit of the bit string may be 0, or 1). The wireless device may perform a first encoding procedure (e.g., across the full alphabet or the decomposed alphabet [symbol] _{16,1}={1, 3}) for the first bit layer 705-a. The second decomposed alphabet [symbol] _{16,2}{1, 3} may apply to the second bit layer 705-b, with a bit width of B₂=1. The decomposed alphabet [symbol] _{16,2} may define a first bit value (e.g., 1 or 0) in the first segment 710-a of the bit layer 705-b and a second bit value (e.g., 1 or 0) in the second segment 710-b of the bit layer 705-b. The wireless device may perform additional encoding procedures for the first segment 710-a and the second segment 710-b of the bit layer 705-b according to the decomposed alphabet [symbol] _{16,2}. The decomposed alphabet [symbol] _{16,1}={1, 3, 5, 7} may define two more bits (e.g., for each symbol) for the bit layer 705-c. Each segment 715 of the bit layer 505-c may define the final two bits in a bit string for an identical prior portion of the bit string (e.g., 00 for symbols 1, 3, 5, and 7, 01 for symbols 9, 11, 13, and 15, and so forth). The decomposed alphabet [symbol] _{16,3}={1, 3, 5, 7} may therefore apply to segment 715-a, segment 715-b, segment 715-c, and segment 715-d of the bit layer 705-c. The wireless device may perform additional encoding procedures for one or more of the segments 715 according to the decomposed alphabet [symbol] _{16,3}. Such encoding procedures, shaping procedures, and bits-to-symbol mapping are described in greater detail with reference to FIG. 8.

FIG. 8 shows an example of an encoding procedure 800 that supports constellation decomposition and compound bit-level and symbol-level probabilistic amplitude shaping in accordance with one or more aspects of the present disclosure. The encoding procedure 800 may implement aspects of, or be implemented by aspects of, the wireless communications system 100, encoding procedure 200, constellation decomposition scheme 300, the encoding procedure 400, the constellation decomposition scheme 500, the encoding procedure 600, the constellation decomposition scheme 700, or any combination thereof. For example, a wireless device may encode a message for transmission to a receiving device according to the encoding procedure 800. In some examples, the receiving device may perform a decoding operation including inverse operations corresponding to the operations of encoding procedure 800.

The wireless device may perform one or more encoding procedures for a bit string (e.g., including one or more bits of a payload, such as u^{k}^{₁}. The wireless device may perform encoding 815-a on a first bit layer (e.g., bit layer 705-a). The encoding 815-a may include a bit-level energy-based encoding procedure. The encoding 815-a may output a quantity of bit streams 830-a (e.g., 2⁰=1 bit streams including bⁿ^{₁}). The wireless device may perform one or more additional encoding procedures (e.g., encoding 820-a for segment 710-a of the bit layer 705-b and encoding 820-b for segment 710-b of the bit layer 705-b). The encodings 820 may be examples of bit-level energy-based encoding procedures. The encoding 820-a may be based on an input of bits 805 (e.g., a remainder of the bit string u^{k}^{_{2,0}} for the first bit of the bit string set to 0) and an input 810-a which may be a sequence (e.g., n_{2, 0}), and the encoding 820-b may be based on an input of bits 805 (e.g., a remainder of the bit string u^{k}^{_{2,1}} for the first bit of the bit string set to 1) and an input 810-b which may be a sequence (e.g., n_{2, 1}). The encoding 820-a may output a first bit stream 830-b based on the sequence sⁿ^{_{2,0}} and the encoding 820-b may output a second bit stream 830-b based on the sequence sⁿ^{_{2,1}}. The encodings 820 may output a quantity 2⁰⁺¹=2 bit streams 830-b.

The wireless device may perform one or more encoding procedures for a bit string (e.g., including one or more bits of a payload, such as u^{k}^{₃}). The encodings 825 may be examples of symbol-level energy-based encoding procedures. The wireless device may perform encodings 825 on various segments 715 of the bit layer 705-c. The encodings 825 may include symbol-level energy-based encoding procedures. Each encoding 825 may receive, as an input, bits 805 (e.g., u^{k}₃), and inputs 810 (e.g., sequences based on the outputs of the encoding 815 and the encodings 820. For example, the encoding 825-a may apply to a final bit of a bit string, based on input 810-c (e.g., n_{3, 00}, corresponding to the first two bits of bit layer 705-a and bit layer 705-b). The encoding 825-b may apply to a final bits of the bit string, based on input 810-d (e.g., n_{3, 01}, corresponding to the first two bits of bit layer 705-a and bit layer 705-b). The encoding 825-c may apply to final bits of the bit string, based on input 810-e (e.g., n_{3, 10}, corresponding to the first two bits of bit layer 705-a and bit layer 705-b Similarly, the input 810-f for the encoding 825-d may be n_{3, 11}.

The encodings 825 may output a quantity of bit streams 830-c (e.g., 2¹⁺¹=4 bit streams). The encoding 825-a may output a sequence sⁿ^{_{3,00}}. The encoding 825-b may output a sequence sⁿ^{_{3,01}}. The encoding 825-c may output a sequence sⁿ^{_{3,10}}. The encoding 825-d may output a sequence sⁿ^{_{3,11}}.

The wireless device may perform bit-to-symbol mapping 835 based on the bit streams 830 (e.g., as described in greater detail with reference to FIG. 4).

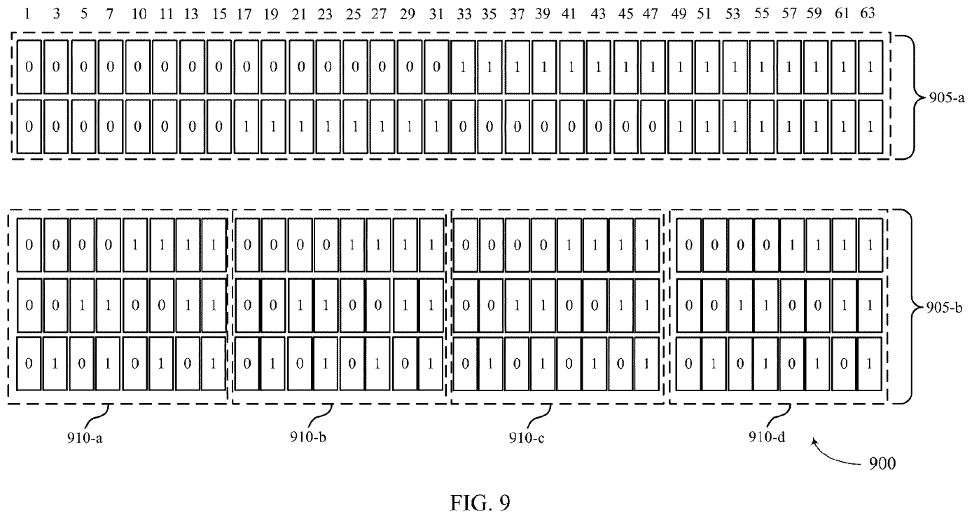

FIG. 9 shows an example of a constellation decomposition scheme 900 that supports constellation decomposition and compound bit-level and symbol-level probabilistic amplitude shaping in accordance with one or more aspects of the present disclosure. In some examples, the constellation decomposition scheme 900 may implement aspects of, or be implemented by aspects of, the wireless communications system 100, encoding procedure 200, constellation decomposition scheme 300, the encoding procedure 400, a constellation decomposition scheme 500, the encoding procedures 600, the constellation decomposition scheme 700, the encoding procedure 800, or any combination thereof. For example, a wireless device may encode a message for transmission to a receiving device according to the constellation decomposition scheme 900. In some examples, the receiving device may perform a decoding operation including inverse operations corresponding to the operations of constellation decomposition scheme 900.

In some examples, the wireless device may perform encoding, shaping, and bits-to-symbol mapping operations as described herein. In some examples, as illustrated with reference to FIG. 9, such procedures may be performed based on an alphabet [symbol] of size m (e.g., [symbol] ) where m=32, a quantity of layers L may be L=2, with 3 bit width B₁, and B₂. For example, bit layer 905-a may have a first bit width of B₁=2, bit layer 905-b may have a second bit width of B₂=3. The wireless device may identify a decomposed alphabet [symbol] _{32,1}={1, 3, 5, 7} for bit layer 905-a, and a decomposed alphabet [symbol] _{32,2}={1, 3, 5, 7, 9, 11, 13, 15} for the bit layer 905-b. Each amplitude symbol a₂∈ [symbol] ₃₂ may correspond to a binary expansion. Such a binary expansion for, for example, symbol 3, may be written as (0, 0, 0, 0, 1), where the first two elements (e.g., 0, 0) correspond to b₁, the next three elements (0, 0, 1) correspond to b₂.

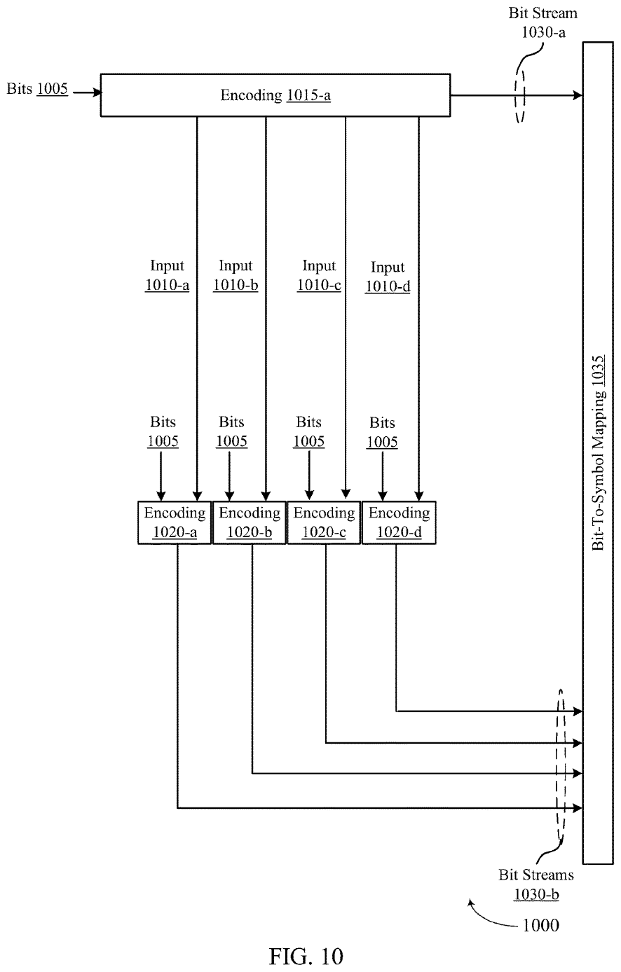

The first decomposed alphabet [symbol] _{32,1}={1, 3, 5, 7} may apply to the first bit layer 905-a. The wireless device may perform a first encoding procedure (e.g., across the full alphabet or the decomposed alphabet [symbol] _{32,1}={1, 3, 5, 7}) for the first bit layer 905-a. The second decomposed alphabet [symbol] _{32,2}={1, 3, 5, 7, 9, 11, 13, 15} may apply to the second bit layer 905-b, with a bit width of B₂=3. The decomposed alphabet [symbol] _{32,2} may define a first bit value (e.g., 1 or 0) in the first segment 910-a of the bit layer 905-b and a second bit value (e.g., 1 or 0) in the second segment 910-b of the bit layer 905-b. The wireless device may perform additional encoding procedures for the third segment 910-c and the fourth segment 910-d of the bit layer 905-b according to the decomposed alphabet [symbol] _{32,2}. The wireless device may perform additional encoding procedures for one or more of the segments 910 according to the decomposed alphabet [symbol] _{32,2}. Such encoding procedures, shaping procedures, and bits-to-symbol mapping are described in greater detail with reference to FIG. 10.

FIG. 10 shows an example of an encoding procedure 1000 that supports constellation decomposition and compound bit-level and symbol-level probabilistic amplitude shaping in accordance with one or more aspects of the present disclosure. The encoding procedure 1000 may implement aspects of, or be implemented by aspects of, the wireless communications system 100, encoding procedure 200, constellation decomposition scheme 300, the encoding procedure 400, the constellation decomposition scheme 500, the encoding procedure 600, the constellation decomposition scheme 700, the encoding procedure 800, the constellation decomposition scheme 900, or any combination thereof. For example, a wireless device may encode a message for transmission to a receiving device according to the encoding procedure 1000. In some examples, the receiving device may perform a decoding operation including inverse operations corresponding to the operations of encoding procedure 1000.

The wireless device may perform one or more encoding procedures for a bit string (e.g., including one or more bits of a payload, such as u^{k}^{₁}. The wireless device may perform encoding 1015-a on a first bit layer (e.g., bit layer 905-a). The encoding 1015-a may include a symbol-level energy-based encoding procedure. The encoding 1015-a may output a quantity of bit streams 1030-a (e.g., 2⁰=1 bit streams including b″1). The wireless device may perform one or more additional encoding procedures (e.g., encoding 1020-a for segment 910-a of the bit layer 705-b, encoding 1020-b for segment 910-b of the bit layer 905-b, encoding 1020-c for segment 910-c of the bit layer 905-b, and encoding 1020-d for segment 910-d of the bit layer 905-b). The encodings 1020 may be examples of symbol-level energy-based encoding procedures. The encoding 1020-a may be based on an input of bits 1005 (e.g., a remainder of the bit string u^{k}^{_{2,0}} for the first bit of the bit string set to 0) and an input 1010-a which may be a sequence (e.g., n_{2, 00}). The encoding 1020-b may be based on an input of bits 1005 and an input 1010-b which may be a sequence (e.g., n_{2, 01}). The encoding 1020-c may be based on an input of bits 1005 and an input 1010-c which may be a sequence (e.g., n_{2, 10}). The encoding 1020-d may be based on an input of bits 1005 and an input 1010-d which may be a sequence (e.g., n_{2, 11}). The quantity of outputs generated by the encodings 1020 may be 2⁰⁺²=4 bit streams (e.g., based on the output sequences Sⁿ).

The encodings 825 may output a quantity of bit streams 830-c (e.g., 2¹⁺¹=4 bit streams). The encoding 825-a may output a sequence sⁿ^{_{3,00}}. The encoding 825-b may output a sequence sⁿ^{_{3,01}}. The encoding 825-c may output a sequence sⁿ^{_{3,10}}. The encoding 825-d may output a sequence sⁿ^{_{3,11}}.

The wireless device may perform bit-to-symbol mapping 1035 based on the bit streams 1030 (e.g., as described in greater detail with reference to FIG. 4).

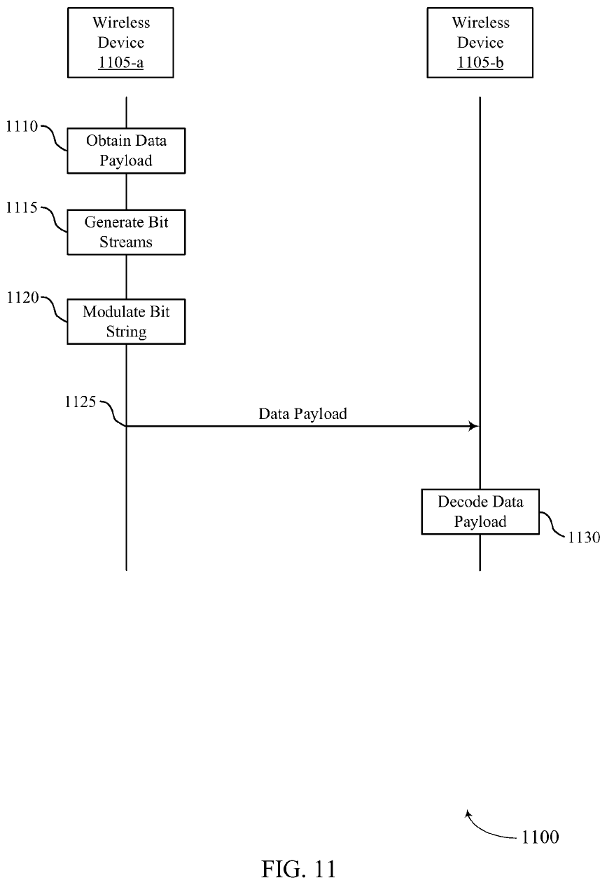

FIG. 11 shows an example of a process flow 1100 that supports constellation decomposition and compound bit-level and symbol-level probabilistic amplitude shaping in accordance with one or more aspects of the present disclosure. The process flow may implement aspects of, or be implemented by aspects of, FIGS. 1-10. For example, the process flow 1100 may include a transmitting wireless device 1105-a and a receiving wireless device 1105-b, which may be examples of corresponding devices (e.g., UEs 115, or network entities 105) as described with reference to FIGS. 1-10.

At 1110, the wireless device 1105-a may obtain a data payload for transmission via a message (e . . . , at 1125). The message may be generated through modulation constellations associated with a first quantity of constellation symbols, each of the first quantity of constellation symbols representative of a respective potential bit string of the data payload. In some examples, quantities of constellation symbols may correspond to deconstructed constellations (e.g., as described with reference to FIG. 5, FIG. 7, and FIG. 9, among other examples).

At 1115, the wireless device 1105-a may generate multiple bit streams (e.g., bit streams 630, 830, and 1030, among other examples) through application of various shaping operations (e.g., which may include encoding procedures and bit-to-symbol mapping procedures described herein) to all or part of an actual bit string of the data payload. One or more of the many shaping operations may be applied to corresponding portions of the actual bit string such that respective bit streams of the multiple bit streams may be associated with one or more second quantities of constellation symbols of the modulation constellation. The one or more second quantities may be less than the first quantity.

At 1120, the wireless device 1105-a may modulate the actual bit string, from the multiple bit streams, to a corresponding constellation symbol of the modulation constellation to generate the message.

In some examples, the corresponding constellation symbol of the modulation constellation is indicated by at least a portion of the multiple bit streams. The multiple bit streams may be organized into groups of bit streams (e.g., bit streams 630, 830, or 1030, among other examples) which contribute to the actual bit string of the corresponding constellation symbol of the modulation constellation. For example, the encoding and shaping procedures described herein may generate various evaluations of constellation points, and a final selection of a constellation point may be transmitted according to an actually selected bit stream (e.g., the bit string). Each group of bit streams may correspond to a respective bit layer (e.g., bit layers 505, 705, or 905, among other examples) having a bit width of one or more bits on which respective one of the plurality of shaping operations are applied.

In some examples, a first shaping operation of the multiple shaping operations may be applied to a first bit layer of the multiple bit layers for the first quantity of constellation symbols (e.g., a first alphabet [symbol] , which may be a decomposed or smaller alphabet, or a full alphabet), and one or more of the shaping operations may be applied to one or more second bit layers of the multiple bit layers for the corresponding second quantities of constellation symbols (e.g., second alphabet [symbol] , which may be a decomposed or smaller alphabet). Each bit layer of the multiple bit layers may correspond to one or more bit levels that correspond to the respective width. In some examples, the first shaping operation may be a bit level energy-based shaping operation (e.g., encoding operation).

In some examples, the one or more of the shaping operations may include one or more symbol-level energy-based shaping operations (e.g., or vice versa). In such examples, the wireless device 1105-a may input the actual bit string to the first shaping operation, and may output, from the first shaping operation, a first shaped bit stream of the multiple bit streams. The wireless device 1105-a may input, to one or more additional shaping operations, a first summary of the first shaping operation) and a first portion of the actual bit string corresponding to the first of the one or more second bit layers (e.g., a first candidate portion of the bit string). In some examples, the wireless device 1105-a may input, to a first of the shaping operations, a first summary of the first shaping operation and a first portion of the actual bit string corresponding to the first of the one or more additional (e.g., second) bit layers, and may input, to a second shaping operation, a second summary of the first shaping operation and a second portion of the actual bit string corresponding to the first of the second or additional bit layers. The first summary and second summary may each pertain to a respective bit value or set of bit values output by the first shaping operations (e.g., inputs 610, 810, and 1010, among other examples). The wireless device 1105-a may output from the first shaping operation a second shaped bit stream, and may output from the second of the shaping operations a third shaped bit stream. The second shaped bit stream and the third shaped bit stream may be associated with the same bit layer (e.g., bit streams 630-b, bit streams 630-c, bit streams 830-b, bit streams 830-c, or bit streams 1030-b, among other examples).

In some examples, the width of each of the second bit layers may correspond to a quantity of bit levels of a respective one of the second bit layers. In some examples, the wireless device 1105-a may perform the first shaping operation and the second shaping operation in parallel. In some examples, the shaping operations may be based on a bit layer shaping parameter that includes a bit layer sequence composition corresponding to the actual bit string. In some cases, the shaping operations may be based on a constant composition distribution matching procedure corresponding to the second quantity of constellation symbols (e.g., the second alphabet).

In some cases, generating the bit streams may include performing multiple iterations of the shaping operations. Each iteration may correspond to a respective bit layer of the multiple bit layers (e.g., as described in greater detail with reference to FIG. 4). In such examples, the wireless device 1105-a may determine a shaping parameter for each iteration of the one or more iterations. The shaping parameter may be based at least in part on a threshold sequence energy, a bit-bit layer sequence energy parameter value, a decomposed alphabet for the second shaping operation, a threshold sequence length, or any combination thereof. The wireless device 1105-a may increment an iteration counter after each of the one or more iterations, and the modulating may be based at least in part on the counter satisfying a threshold quantity of iterations. The wireless device 1105-a may input for each limitation of the one or more iterations subsequent to a first iteration of the one or more iterations, a first portion of the actual bit string, the first portion having a sequence length based at least in part on an output sequence of bits of a previous iteration of the one or more iterations. In some examples, the wireless device 1105-a may input the actual bit string as the input for a single iteration.

The wireless device 1105-a may sequentially read elements from the respective bit streams of the multiple bit streams based on an increasing order of bit layers from a first bit layer to a last bit layer of the multiple bit layers.

At 1125, the wireless device 1105-a may transmit the data payload via the message, to the wireless device 1105-b.

At 1130, the wireless device 1105-b may decode the data payload. The wireless device 1105-b may decode the data payload using an inverse of the encoding and shaping techniques described herein.

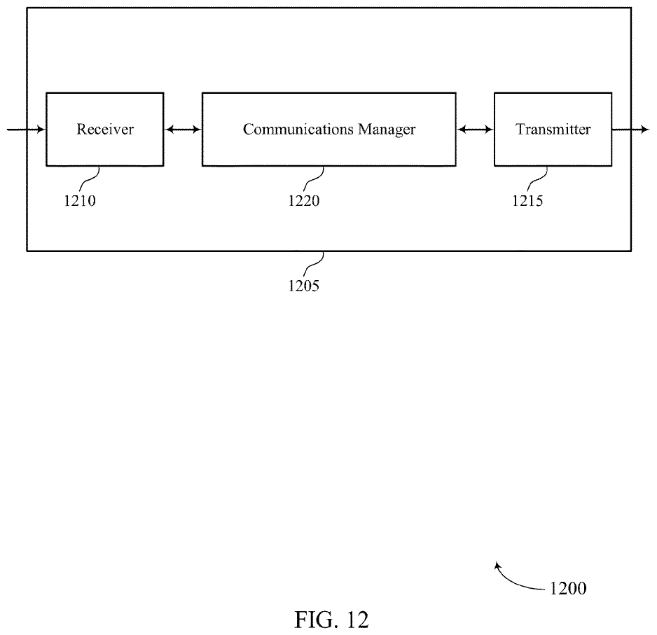

FIG. 12 shows a block diagram 1200 of a device 1205 that supports constellation decomposition and compound bit-level and symbol-level probabilistic amplitude shaping in accordance with one or more aspects of the present disclosure. The device 1205 may be an example of aspects of a UE 115 or a network entity 105 as described herein. The device 1205 may include a receiver 1210, a transmitter 1215, and a communications manager 1220. The device 1205, or one or more components of the device 1205 (e.g., the receiver 1210, the transmitter 1215, and the communications manager 1220), may include at least one processor, which may be coupled with at least one memory, to, individually or collectively, support or enable the described techniques. Each of these components may be in communication with one another (e.g., via one or more buses).

The receiver 1210 may provide a means for receiving information such as packets, user data, control information, or any combination thereof associated with various information channels (e.g., control channels, data channels, information channels related to constellation decomposition and compound bit-level and symbol-level probabilistic amplitude shaping). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to constellation decomposition and compound bit-level and symbol-level probabilistic amplitude shaping). In some examples, the transmitter 1215 may be co-located with a receiver 1210 in a transceiver module. The transmitter 1215 may utilize a single antenna or a set of multiple antennas.

The communications manager 1220, the receiver 1210, the transmitter 1215, or various combinations thereof or various components thereof may be examples of means for performing various aspects of constellation decomposition and compound bit-level and symbol-level probabilistic amplitude shaping as described herein. For example, the communications manager 1220, the receiver 1210, the transmitter 1215, or various combinations or components thereof may be capable of performing one or more of the functions described herein.

In some examples, the communications manager 1220, the receiver 1210, the transmitter 1215, or various combinations or components thereof may be implemented in hardware (e.g., in communications management circuitry). The hardware may include at least one of a processor, a digital signal processor (DSP), a central processing unit (CPU), a graphics processing unit (GPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1220, the receiver 1210, the transmitter 1215, or various combinations or components thereof may be implemented in code (e.g., as communications management software) executed by at least one processor. If implemented in code executed by at least one processor, the functions of the communications manager 1220, the receiver 1210, the transmitter 1215, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications at a first wireless device in accordance with examples as disclosed herein. For example, the communications manager 1220 is capable of, configured to, or operable to support a means for obtaining a data payload for transmission via a message, where the message is generated through a modulation constellation associated with a first quantity of constellation symbols, each of the first quantity of constellation symbols representative of a respective potential bit string of the data payload. The communications manager 1220 is capable of, configured to, or operable to support a means for generating a set of multiple bit streams through application of a set of multiple shaping operations to all or part of an actual bit string of the data payload, where one or more of the set of multiple shaping operations are applied to corresponding portions of the actual bit string such that respective bit streams of the set of multiple bit streams are associated with one or more second quantities of constellation symbols of the modulation constellation, where the one or more second quantities are less than the first quantity. The communications manager 1220 is capable of, configured to, or operable to support a means for modulating the actual bit string to a corresponding constellation symbol of the modulation constellation to generate the message. The communications manager 1220 is capable of, configured to, or operable to support a means for transmitting the data payload via the message to a second wireless device.

By including or configuring the communications manager 1220 in accordance with examples as described herein, the device 1205 (e.g., at least one processor controlling or otherwise coupled with the receiver 1210, the transmitter 1215, the communications manager 1220, or a combination thereof) may support techniques for shaping and encoding that result in less processing burden on the wireless device, more efficient utilization of processing resources, decreased latency, and improved throughput.

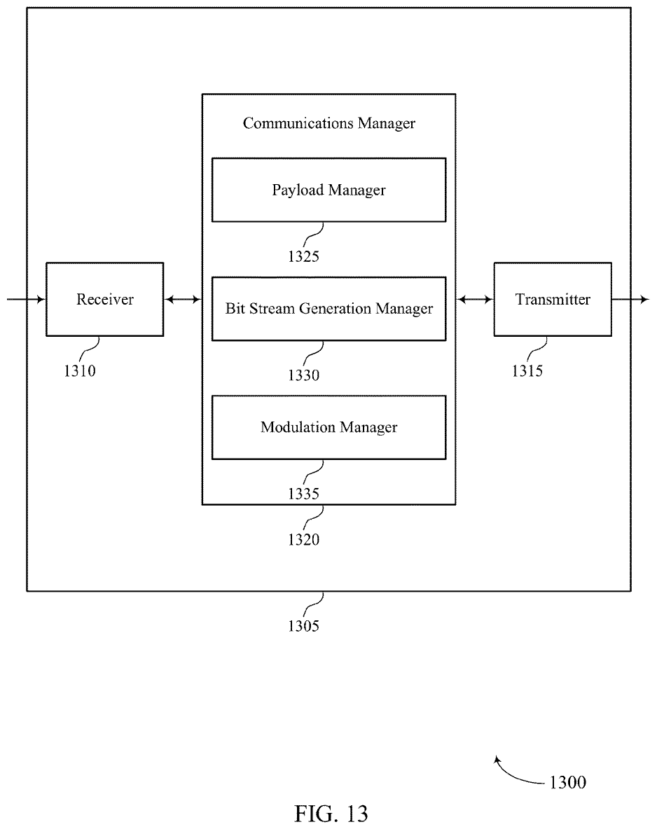

FIG. 13 shows a block diagram 1300 of a device 1305 that supports constellation decomposition and compound bit-level and symbol-level probabilistic amplitude shaping in accordance with one or more aspects of the present disclosure. The device 1305 may be an example of aspects of a device 1205, a UE 115, or a network entity 105 as described herein. The device 1305 may include a receiver 1310, a transmitter 1315, and a communications manager 1320. The device 1305, or one of more components of the device 1305 (e.g., the receiver 1310, the transmitter 1315, and the communications manager 1320), may include at least one processor, which may be coupled with at least one memory, to support the described techniques. Each of these components may be in communication with one another (e.g., via one or more buses).

The receiver 1310 may provide a means for receiving information such as packets, user data, control information, or any combination thereof associated with various information channels (e.g., control channels, data channels, information channels related to constellation decomposition and compound bit-level and symbol-level probabilistic amplitude shaping). Information may be passed on to other components of the device 1305. The receiver 1310 may utilize a single antenna or a set of multiple antennas.

The transmitter 1315 may provide a means for transmitting signals generated by other components of the device 1305. For example, the transmitter 1315 may transmit information such as packets, user data, control information, or any combination thereof associated with various information channels (e.g., control channels, data channels, information channels related to constellation decomposition and compound bit-level and symbol-level probabilistic amplitude shaping). In some examples, the transmitter 1315 may be co-located with a receiver 1310 in a transceiver module. The transmitter 1315 may utilize a single antenna or a set of multiple antennas.

The device 1305, or various components thereof, may be an example of means for performing various aspects of constellation decomposition and compound bit-level and symbol-level probabilistic amplitude shaping as described herein. For example, the communications manager 1320 may include a payload manager 1325, a bit stream generation manager 1330, a modulation manager 1335, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications at a first wireless device in accordance with examples as disclosed herein. The payload manager 1325 is capable of, configured to, or operable to support a means for obtaining a data payload for transmission via a message, where the message is generated through a modulation constellation associated with a first quantity of constellation symbols, each of the first quantity of constellation symbols representative of a respective potential bit string of the data payload. The bit stream generation manager 1330 is capable of, configured to, or operable to support a means for generating a set of multiple bit streams through application of a set of multiple shaping operations to all or part of an actual bit string of the data payload, where one or more of the set of multiple shaping operations are applied to corresponding portions of the actual bit string such that respective bit streams of the set of multiple bit streams are associated with one or more second quantities of constellation symbols of the modulation constellation, where the one or more second quantities are less than the first quantity. The modulation manager 1335 is capable of, configured to, or operable to support a means for modulating the actual bit string to a corresponding constellation symbol of the modulation constellation to generate the message. The payload manager 1325 is capable of, configured to, or operable to support a means for transmitting the data payload via the message to a second wireless device.

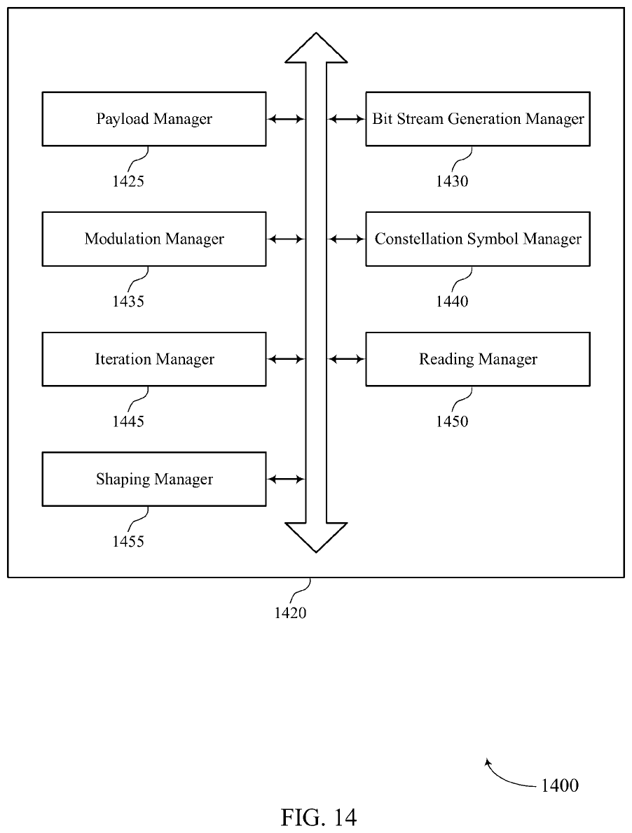

FIG. 14 shows a block diagram 1400 of a communications manager 1420 that supports constellation decomposition and compound bit-level and symbol-level probabilistic amplitude shaping in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of constellation decomposition and compound bit-level and symbol-level probabilistic amplitude shaping as described herein. For example, the communications manager 1420 may include a payload manager 1425, a bit stream generation manager 1430, a modulation manager 1435, a constellation symbol manager 1440, an iteration manager 1445, a reading manager 1450, a shaping manager 1455, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1420 may support wireless communications at a first wireless device in accordance with examples as disclosed herein. The payload manager 1425 is capable of, configured to, or operable to support a means for obtaining a data payload for transmission via a message, where the message is generated through a modulation constellation associated with a first quantity of constellation symbols, each of the first quantity of constellation symbols representative of a respective potential bit string of the data payload. The bit stream generation manager 1430 is capable of, configured to, or operable to support a means for generating a set of multiple bit streams through application of a set of multiple shaping operations to all or part of an actual bit string of the data payload, where one or more of the set of multiple shaping operations are applied to corresponding portions of the actual bit string such that respective bit streams of the set of multiple bit streams are associated with one or more second quantities of constellation symbols of the modulation constellation, where the one or more second quantities are less than the first quantity. The modulation manager 1435 is capable of, configured to, or operable to support a means for modulating the actual bit string to a corresponding constellation symbol of the modulation constellation to generate the message. In some examples, the payload manager 1425 is capable of, configured to, or operable to support a means for transmitting the data payload via the message to a second wireless device.

In some examples, the corresponding constellation symbol of the modulation constellation is indicated by at least a portion of the set of multiple bit streams, where the set of multiple bit streams are organized into groups of bit streams, each group including one bit stream which contributes to the actual bit string of the corresponding constellation symbol of the modulation constellation.

In some examples, each group of bit streams corresponds to a respective bit layer having a width of one or more bits on which respective ones of the set of multiple shaping operations are applied.

In some examples, a first shaping operation of the set of multiple shaping operations is applied to a first bit layer of a set of multiple bit layers for the first quantity of constellation symbols. In some examples, the one or more of the set of multiple shaping operations are applied to one or more second bit layers of the set of multiple bit layers for the corresponding one or more second quantities of constellation symbols, each bit layer of the set of multiple bit layers corresponding to one or more bit levels that correspond to the respective width.

In some examples, the first shaping operation is a bit level energy-based shaping operation. In some examples, the one or more of the set of multiple shaping operations include one or more symbol-level energy-based shaping operations.

In some examples, the shaping manager 1455 is capable of, configured to, or operable to support a means for inputting the actual bit string to the first shaping operation. In some examples, the shaping manager 1455 is capable of, configured to, or operable to support a means for outputting, from the first shaping operation, a first shaped bit stream of the set of multiple bit streams.

In some examples, the shaping manager 1455 is capable of, configured to, or operable to support a means for inputting, to a first of the one or more of the set of multiple shaping operations, a first summary of the first shaping operation and a first portion of the actual bit string corresponding to a first of the one or more second bit layers. In some examples, the shaping manager 1455 is capable of, configured to, or operable to support a means for inputting, to a second of the one or more of the set of multiple shaping operations, a second summary of the first shaping operation and a second portion of the actual bit string corresponding to the first of the one or more second bit layers, where the first summary and the second summary each pertain to a respective bit value output by the first shaping operation. In some examples, the shaping manager 1455 is capable of, configured to, or operable to support a means for outputting, from the first of the one or more of the set of multiple shaping operations, a second shaped bit stream of the set of multiple bit streams. In some examples, the shaping manager 1455 is capable of, configured to, or operable to support a means for outputting, from the second of the one or more of the set of multiple shaping operations, a third shaped bit stream of the set of multiple bit streams, where the second shaped bit stream and the third shaped bit stream are both associated with a same bit layer.

In some examples, a width of each of the one or more second bit layers correspond to a quantity of bit levels of a respective one of the one or more second bit layers.

In some examples, to support generating the set of multiple bit streams, the shaping manager 1455 is capable of, configured to, or operable to support a means for performing the first of the one or more of the set of multiple shaping operations and the second of the one or more of the set of multiple shaping operations in parallel.

In some examples, one or more of the set of multiple shaping operations is based on a bit layer shaping parameter including a bit layer sequence composition corresponding to the actual bit string.

In some examples, one or more of the set of multiple shaping operations is based on a constant composition distribution matching procedure corresponding to the second quantity of constellation symbols.

In some examples, to support generating the set of multiple bit streams, the iteration manager 1445 is capable of, configured to, or operable to support a means for performing one or more iterations of a first shaping operation and a second shaping operation of the set of multiple shaping operations, each iteration of the one or more iterations corresponding to a respective bit layer of a set of multiple bit layers.

In some examples, the iteration manager 1445 is capable of, configured to, or operable to support a means for determining a shaping parameter for each iteration of the one or more iterations, the shaping parameter based on a threshold sequence energy, a bit-bit layer sequence energy parameter value, a decomposed alphabet for the second shaping operation, a threshold sequence length, or any combination thereof.

In some examples, the iteration manager 1445 is capable of, configured to, or operable to support a means for incrementing an iteration counter after each of the one or more iterations, where the modulating is based on the counter satisfying a threshold quantity of iterations.

In some examples, the iteration manager 1445 is capable of, configured to, or operable to support a means for inputting, for each iteration of the one or more iterations subsequent to a first iteration of the one or more iterations, a first portion of the actual bit string, the first portion having a sequence length based on an output sequence of bits of a previous iteration of the one or more iterations.

In some examples, the iteration manager 1445 is capable of, configured to, or operable to support a means for inputting, for the one or more iterations including a single iteration, the actual bit string.

In some examples, to support modulating, the reading manager 1450 is capable of, configured to, or operable to support a means for sequentially reading elements from the respective bit streams of the set of multiple bit streams based on an increasing order of bit layers from a first bit layer to a last bit layer of a set of multiple bit layers.

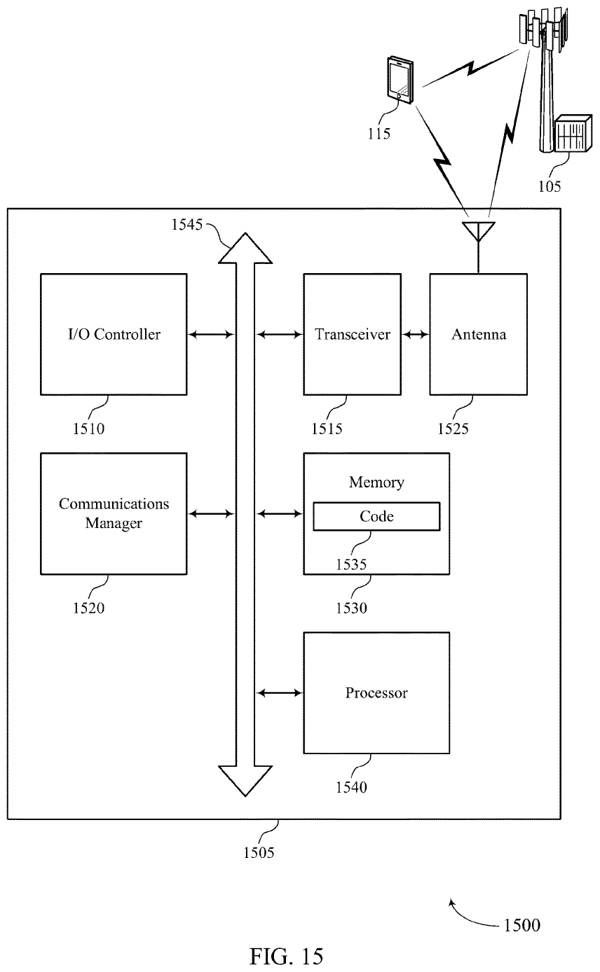

FIG. 15 shows a diagram of a system 1500 including a device 1505 that supports constellation decomposition and compound bit-level and symbol-level probabilistic amplitude shaping in accordance with one or more aspects of the present disclosure. The device 1505 may be an example of or include the components of a device 1205, a device 1305, or a UE 115 as described herein. The device 1505 may communicate (e.g., wirelessly) with one or more network entities 105, one or more UEs 115, or any combination thereof. The device 1505 may include components for bi-directional voice and data communications including components for transmitting and receiving communications, such as a communications manager 1520, an input/output (I/O) controller 1510, a transceiver 1515, an antenna 1525, at least one memory 1530, code 1535, and at least one processor 1540. These components may be in electronic communication or otherwise coupled (e.g., operatively, communicatively, functionally, electronically, electrically) via one or more buses (e.g., a bus 1545).

The I/O controller 1510 may manage input and output signals for the device 1505. The I/O controller 1510 may also manage peripherals not integrated into the device 1505. In some cases, the I/O controller 1510 may represent a physical connection or port to an external peripheral. In some cases, the I/O controller 1510 may utilize an operating system such as iOS®, ANDROID®, MS-DOS®, MS-WINDOWS®, OS/2®, UNIX®, LINUX®, or another known operating system. Additionally or alternatively, the I/O controller 1510 may represent or interact with a modem, a keyboard, a mouse, a touchscreen, or a similar device. In some cases, the I/O controller 1510 may be implemented as part of one or more processors, such as the at least one processor 1540. In some cases, a user may interact with the device 1505 via the I/O controller 1510 or via hardware components controlled by the I/O controller 1510.

In some cases, the device 1505 may include a single antenna 1525. However, in some other cases, the device 1505 may have more than one antenna 1525, which may be capable of concurrently transmitting or receiving multiple wireless transmissions. The transceiver 1515 may communicate bi-directionally, via the one or more antennas 1525, wired, or wireless links as described herein. For example, the transceiver 1515 may represent a wireless transceiver and may communicate bi-directionally with another wireless transceiver. The transceiver 1515 may also include a modem to modulate the packets, to provide the modulated packets to one or more antennas 1525 for transmission, and to demodulate packets received from the one or more antennas 1525. The transceiver 1515, or the transceiver 1515 and one or more antennas 1525, may be an example of a transmitter 1215, a transmitter 1315, a receiver 1210, a receiver 1310, or any combination thereof or component thereof, as described herein.

The at least one memory 1530 may include random access memory (RAM) and read-only memory (ROM). The at least one memory 1530 may store computer-readable, computer-executable code 1535 including instructions that, when executed by the at least one processor 1540, cause the device 1505 to perform various functions described herein. The code 1535 may be stored in a non-transitory computer-readable medium such as system memory or another type of memory. In some cases, the code 1535 may not be directly executable by the at least one processor 1540 but may cause a computer (e.g., when compiled and executed) to perform functions described herein. In some cases, the at least one memory 1530 may contain, among other things, a basic I/O system (BIOS) which may control basic hardware or software operation such as the interaction with peripheral components or devices.

The at least one processor 1540 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the at least one processor 1540 may be configured to operate a memory array using a memory controller. In some other cases, a memory controller may be integrated into the at least one processor 1540. The at least one processor 1540 may be configured to execute computer-readable instructions stored in a memory (e.g., the at least one memory 1530) to cause the device 1505 to perform various functions (e.g., functions or tasks supporting constellation decomposition and compound bit-level and symbol-level probabilistic amplitude shaping). For example, the device 1505 or a component of the device 1505 may include at least one processor 1540 and at least one memory 1530 coupled with or to the at least one processor 1540, the at least one processor 1540 and at least one memory 1530 configured to perform various functions described herein. In some examples, the at least one processor 1540 may include multiple processors and the at least one memory 1530 may include multiple memories. One or more of the multiple processors may be coupled with one or more of the multiple memories, which may, individually or collectively, be configured to perform various functions herein.

The communications manager 1520 may support wireless communications at a first wireless device in accordance with examples as disclosed herein. For example, the communications manager 1520 is capable of, configured to, or operable to support a means for obtaining a data payload for transmission via a message, where the message is generated through a modulation constellation associated with a first quantity of constellation symbols, each of the first quantity of constellation symbols representative of a respective potential bit string of the data payload. The communications manager 1520 is capable of, configured to, or operable to support a means for generating a set of multiple bit streams through application of a set of multiple shaping operations to all or part of an actual bit string of the data payload, where one or more of the set of multiple shaping operations are applied to corresponding portions of the actual bit string such that respective bit streams of the set of multiple bit streams are associated with one or more second quantities of constellation symbols of the modulation constellation, where the one or more second quantities are less than the first quantity. The communications manager 1520 is capable of, configured to, or operable to support a means for modulating the actual bit string to a corresponding constellation symbol of the modulation constellation to generate the message. The communications manager 1520 is capable of, configured to, or operable to support a means for transmitting the data payload via the message to a second wireless device.

By including or configuring the communications manager 1520 in accordance with examples as described herein, the device 1505 may support techniques for shaping and encoding that result in less processing burden on the wireless device, more efficient utilization of processing resources, decreased latency, and improved throughput.

In some examples, the communications manager 1520 may be configured to perform various operations (e.g., receiving, monitoring, transmitting) using or otherwise in cooperation with the transceiver 1515, the one or more antennas 1525, or any combination thereof. Although the communications manager 1520 is illustrated as a separate component, in some examples, one or more functions described with reference to the communications manager 1520 may be supported by or performed by the at least one processor 1540, the at least one memory 1530, the code 1535, or any combination thereof. For example, the code 1535 may include instructions executable by the at least one processor 1540 to cause the device 1505 to perform various aspects of constellation decomposition and compound bit-level and symbol-level probabilistic amplitude shaping as described herein, or the at least one processor 1540 and the at least one memory 1530 may be otherwise configured to, individually or collectively, perform or support such operations.

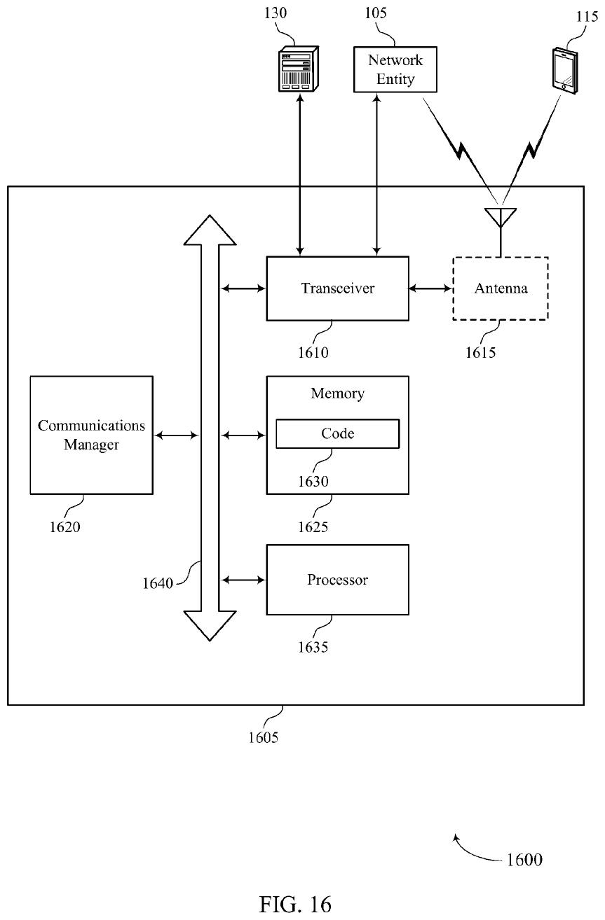

FIG. 16 shows a diagram of a system 1600 including a device 1605 that supports constellation decomposition and compound bit-level and symbol-level probabilistic amplitude shaping in accordance with one or more aspects of the present disclosure. The device 1605 may be an example of or include the components of a device 1205, a device 1305, or a network entity 105 as described herein. The device 1605 may communicate with one or more network entities 105, one or more UEs 115, or any combination thereof, which may include communications over one or more wired interfaces, over one or more wireless interfaces, or any combination thereof. The device 1605 may include components that support outputting and obtaining communications, such as a communications manager 1620, a transceiver 1610, an antenna 1615, at least one memory 1625, code 1630, and at least one processor 1635. These components may be in electronic communication or otherwise coupled (e.g., operatively, communicatively, functionally, electronically, electrically) via one or more buses (e.g., a bus 1640).

The transceiver 1610 may support bi-directional communications via wired links, wireless links, or both as described herein. In some examples, the transceiver 1610 may include a wired transceiver and may communicate bi-directionally with another wired transceiver. Additionally, or alternatively, in some examples, the transceiver 1610 may include a wireless transceiver and may communicate bi-directionally with another wireless transceiver. In some examples, the device 1605 may include one or more antennas 1615, which may be capable of transmitting or receiving wireless transmissions (e.g., concurrently). The transceiver 1610 may also include a modem to modulate signals, to provide the modulated signals for transmission (e.g., by one or more antennas 1615, by a wired transmitter), to receive modulated signals (e.g., from one or more antennas 1615, from a wired receiver), and to demodulate signals. In some implementations, the transceiver 1610 may include one or more interfaces, such as one or more interfaces coupled with the one or more antennas 1615 that are configured to support various receiving or obtaining operations, or one or more interfaces coupled with the one or more antennas 1615 that are configured to support various transmitting or outputting operations, or a combination thereof. In some implementations, the transceiver 1610 may include or be configured for coupling with one or more processors or one or more memory components that are operable to perform or support operations based on received or obtained information or signals, or to generate information or other signals for transmission or other outputting, or any combination thereof. In some implementations, the transceiver 1610, or the transceiver 1610 and the one or more antennas 1615, or the transceiver 1610 and the one or more antennas 1615 and one or more processors or one or more memory components (e.g., the at least one processor 1635, the at least one memory 1625, or both), may be included in a chip or chip assembly that is installed in the device 1605. In some examples, the transceiver 1610 may be operable to support communications via one or more communications links (e.g., a communication link 125, a backhaul communication link 120, a midhaul communication link 162, a fronthaul communication link 168).

The at least one memory 1625 may include RAM, ROM, or any combination thereof. The at least one memory 1625 may store computer-readable, computer-executable code 1630 including instructions that, when executed by one or more of the at least one processor 1635, cause the device 1605 to perform various functions described herein. The code 1630 may be stored in a non-transitory computer-readable medium such as system memory or another type of memory. In some cases, the code 1630 may not be directly executable by a processor of the at least one processor 1635 but may cause a computer (e.g., when compiled and executed) to perform functions described herein. In some cases, the at least one memory 1625 may contain, among other things, a BIOS which may control basic hardware or software operation such as the interaction with peripheral components or devices. In some examples, the at least one processor 1635 may include multiple processors and the at least one memory 1625 may include multiple memories. One or more of the multiple processors may be coupled with one or more of the multiple memories which may, individually or collectively, be configured to perform various functions herein (for example, as part of a processing system).

The at least one processor 1635 may include an intelligent hardware device (e.g., a general-purpose processor, a DSP, an ASIC, a CPU, a GPU, an FPGA, a microcontroller, a programmable logic device, discrete gate or transistor logic, a discrete hardware component, or any combination thereof). In some cases, the at least one processor 1635 may be configured to operate a memory array using a memory controller. In some other cases, a memory controller may be integrated into one or more of the at least one processor 1635. The at least one processor 1635 may be configured to execute computer-readable instructions stored in a memory (e.g., one or more of the at least one memory 1625) to cause the device 1605 to perform various functions (e.g., functions or tasks supporting constellation decomposition and compound bit-level and symbol-level probabilistic amplitude shaping). For example, the device 1605 or a component of the device 1605 may include at least one processor 1635 and at least one memory 1625 coupled with one or more of the at least one processor 1635, the at least one processor 1635 and the at least one memory 1625 configured to perform various functions described herein. The at least one processor 1635 may be an example of a cloud-computing platform (e.g., one or more physical nodes and supporting software such as operating systems, virtual machines, or container instances) that may host the functions (e.g., by executing code 1630) to perform the functions of the device 1605. The at least one processor 1635 may be any one or more suitable processors capable of executing scripts or instructions of one or more software programs stored in the device 1605 (such as within one or more of the at least one memory 1625). In some implementations, the at least one processor 1635 may be a component of a processing system. A processing system may generally refer to a system or series of machines or components that receives inputs and processes the inputs to produce a set of outputs (which may be passed to other systems or components of, for example, the device 1605). For example, a processing system of the device 1605 may refer to a system including the various other components or subcomponents of the device 1605, such as the at least one processor 1635, or the transceiver 1610, or the communications manager 1620, or other components or combinations of components of the device 1605. The processing system of the device 1605 may interface with other components of the device 1605, and may process information received from other components (such as inputs or signals) or output information to other components. For example, a chip or modem of the device 1605 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1605 may transmit information output from the chip or modem. Additionally, or alternatively, in some implementations, the one or more interfaces may refer to an interface between the processing system of the chip or modem and a receiver, such that the device 1605 may obtain information or signal inputs, and the information may be passed to the processing system. A person having ordinary skill in the art will readily recognize that a first interface also may obtain information or signal inputs, and a second interface also may output information or signal outputs.

In some examples, a bus 1640 may support communications of (e.g., within) a protocol layer of a protocol stack. In some examples, a bus 1640 may support communications associated with a logical channel of a protocol stack (e.g., between protocol layers of a protocol stack), which may include communications performed within a component of the device 1605, or between different components of the device 1605 that may be co-located or located in different locations (e.g., where the device 1605 may refer to a system in which one or more of the communications manager 1620, the transceiver 1610, the at least one memory 1625, the code 1630, and the at least one processor 1635 may be located in one of the different components or divided between different components).

In some examples, the communications manager 1620 may manage aspects of communications with a core network 130 (e.g., via one or more wired or wireless backhaul links). For example, the communications manager 1620 may manage the transfer of data communications for client devices, such as one or more UEs 115. In some examples, the communications manager 1620 may manage communications with other network entities 105, and may include a controller or scheduler for controlling communications with UEs 115 in cooperation with other network entities 105. In some examples, the communications manager 1620 may support an X2 interface within an LTE/LTE-A wireless communications network technology to provide communication between network entities 105.

The communications manager 1620 may support wireless communications at a first wireless device in accordance with examples as disclosed herein. For example, the communications manager 1620 is capable of, configured to, or operable to support a means for obtaining a data payload for transmission via a message, where the message is generated through a modulation constellation associated with a first quantity of constellation symbols, each of the first quantity of constellation symbols representative of a respective potential bit string of the data payload. The communications manager 1620 is capable of, configured to, or operable to support a means for generating a set of multiple bit streams through application of a set of multiple shaping operations to all or part of an actual bit string of the data payload, where one or more of the set of multiple shaping operations are applied to corresponding portions of the actual bit string such that respective bit streams of the set of multiple bit streams are associated with one or more second quantities of constellation symbols of the modulation constellation, where the one or more second quantities are less than the first quantity. The communications manager 1620 is capable of, configured to, or operable to support a means for modulating the actual bit string to a corresponding constellation symbol of the modulation constellation to generate the message. The communications manager 1620 is capable of, configured to, or operable to support a means for transmitting the data payload via the message to a second wireless device.

By including or configuring the communications manager 1620 in accordance with examples as described herein, the device 1605 may support techniques for shaping and encoding that result in less processing burden on the wireless device, more efficient utilization of processing resources, decreased latency, and improved throughput.

In some examples, the communications manager 1620 may be configured to perform various operations (e.g., receiving, obtaining, monitoring, outputting, transmitting) using or otherwise in cooperation with the transceiver 1610, the one or more antennas 1615 (e.g., where applicable), or any combination thereof. Although the communications manager 1620 is illustrated as a separate component, in some examples, one or more functions described with reference to the communications manager 1620 may be supported by or performed by the transceiver 1610, one or more of the at least one processor 1635, one or more of the at least one memory 1625, the code 1630, or any combination thereof (for example, by a processing system including at least a portion of the at least one processor 1635, the at least one memory 1625, the code 1630, or any combination thereof). For example, the code 1630 may include instructions executable by one or more of the at least one processor 1635 to cause the device 1605 to perform various aspects of constellation decomposition and compound bit-level and symbol-level probabilistic amplitude shaping as described herein, or the at least one processor 1635 and the at least one memory 1625 may be otherwise configured to, individually or collectively, perform or support such operations.

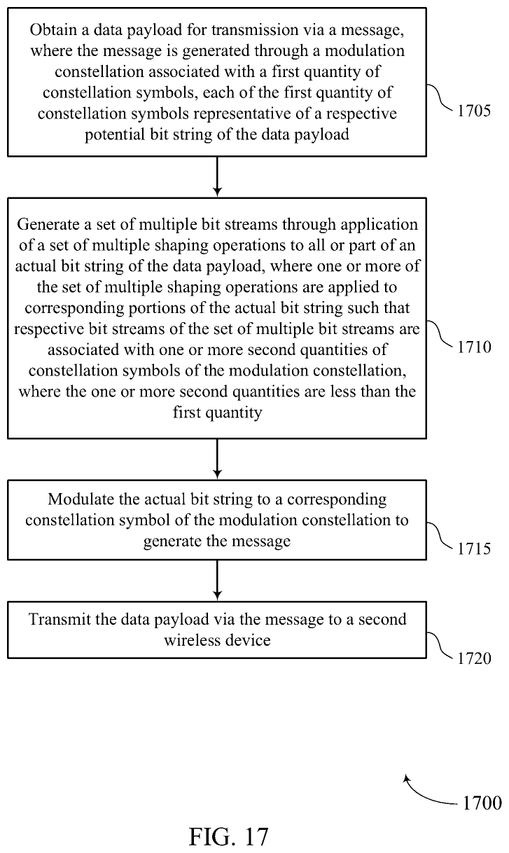

FIG. 17 shows a flowchart illustrating a method 1700 that supports constellation decomposition and compound bit-level and symbol-level probabilistic amplitude shaping in accordance with aspects of the present disclosure. The operations of the method 1700 may be implemented by a UE or a network entity or its components as described herein. For example, the operations of the method 1700 may be performed by a UE 115 or a network entity as described with reference to FIGS. 1 through 16. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1705, the method may include obtaining a data payload for transmission via a message, where the message is generated through a modulation constellation associated with a first quantity of constellation symbols, each of the first quantity of constellation symbols representative of a respective potential bit string of the data payload. The operations of block 1705 may be performed in accordance with examples as disclosed herein. In some examples, aspects of the operations of 1705 may be performed by a payload manager 1425 as described with reference to FIG. 14.

At 1710, the method may include generating a set of multiple bit streams through application of a set of multiple shaping operations to all or part of an actual bit string of the data payload, where one or more of the set of multiple shaping operations are applied to corresponding portions of the actual bit string such that respective bit streams of the set of multiple bit streams are associated with one or more second quantities of constellation symbols of the modulation constellation, where the one or more second quantities are less than the first quantity. The operations of block 1710 may be performed in accordance with examples as disclosed herein. In some examples, aspects of the operations of 1710 may be performed by a bit stream generation manager 1430 as described with reference to FIG. 14.

At 1715, the method may include modulating the actual bit string to a corresponding constellation symbol of the modulation constellation to generate the message. The operations of block 1715 may be performed in accordance with examples as disclosed herein. In some examples, aspects of the operations of 1715 may be performed by a modulation manager 1435 as described with reference to FIG. 14.

At 1720, the method may include transmitting the data payload via the message to a second wireless device. The operations of block 1720 may be performed in accordance with examples as disclosed herein. In some examples, aspects of the operations of 1720 may be performed by a payload manager 1425 as described with reference to FIG. 14.

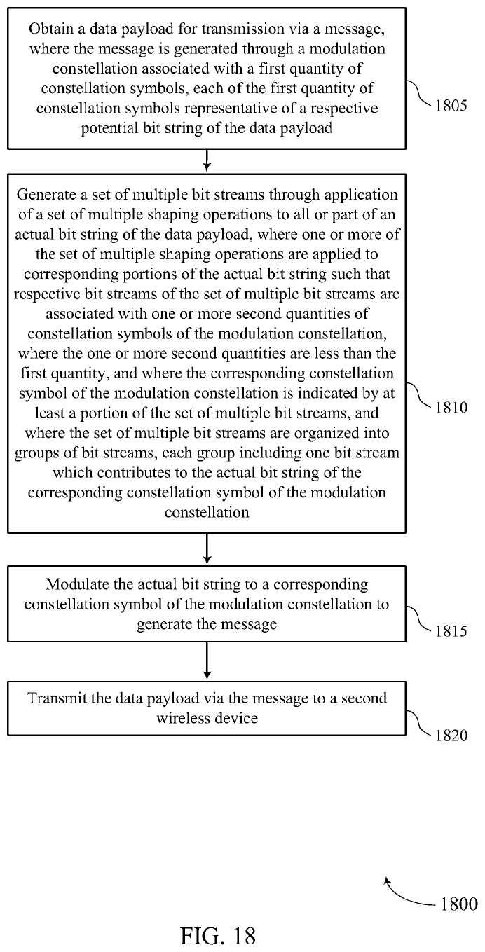

FIG. 18 shows a flowchart illustrating a method 1800 that supports constellation decomposition and compound bit-level and symbol-level probabilistic amplitude shaping in accordance with aspects of the present disclosure. The operations of the method 1800 may be implemented by a UE or a network entity or its components as described herein. For example, the operations of the method 1800 may be performed by a UE 115 or a network entity as described with reference to FIGS. 1 through 16. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1805, the method may include obtaining a data payload for transmission via a message, where the message is generated through a modulation constellation associated with a first quantity of constellation symbols, each of the first quantity of constellation symbols representative of a respective potential bit string of the data payload. The operations of block 1805 may be performed in accordance with examples as disclosed herein. In some examples, aspects of the operations of 1805 may be performed by a payload manager 1425 as described with reference to FIG. 14.

At 1810, the method may include generating a set of multiple bit streams through application of a set of multiple shaping operations to all or part of an actual bit string of the data payload, where one or more of the set of multiple shaping operations are applied to corresponding portions of the actual bit string such that respective bit streams of the set of multiple bit streams are associated with one or more second quantities of constellation symbols of the modulation constellation, where the one or more second quantities are less than the first quantity, and where the corresponding constellation symbol of the modulation constellation is indicated by at least a portion of the set of multiple bit streams, and where the set of multiple bit streams are organized into groups of bit streams, each group including one bit stream which contributes to the actual bit string of the corresponding constellation symbol of the modulation constellation. The operations of block 1810 may be performed in accordance with examples as disclosed herein. In some examples, aspects of the operations of 1810 may be performed by a bit stream generation manager 1430 as described with reference to FIG. 14.

At 1815, the method may include modulating the actual bit string to a corresponding constellation symbol of the modulation constellation to generate the message. The operations of block 1815 may be performed in accordance with examples as disclosed herein. In some examples, aspects of the operations of 1815 may be performed by a modulation manager 1435 as described with reference to FIG. 14.

At 1820, the method may include transmitting the data payload via the message to a second wireless device. The operations of block 1820 may be performed in accordance with examples as disclosed herein. In some examples, aspects of the operations of 1820 may be performed by a payload manager 1425 as described with reference to FIG. 14.

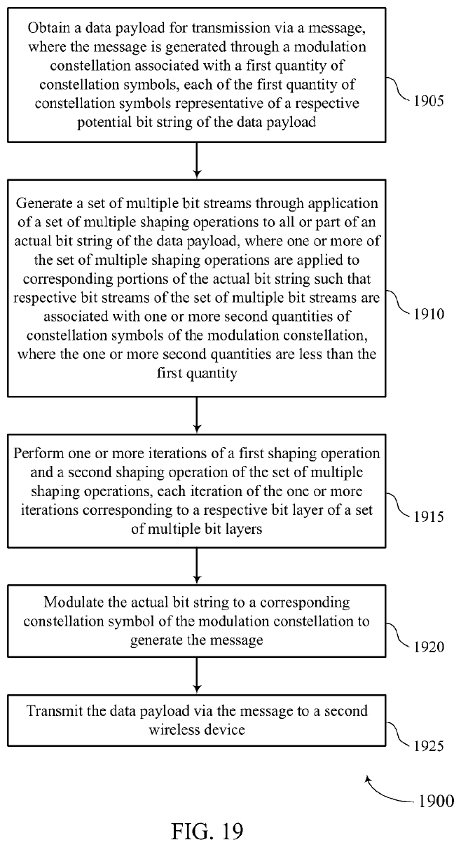

FIG. 19 shows a flowchart illustrating a method 1900 that supports constellation decomposition and compound bit-level and symbol-level probabilistic amplitude shaping in accordance with aspects of the present disclosure. The operations of the method 1900 may be implemented by a UE or a network entity or its components as described herein. For example, the operations of the method 1900 may be performed by a UE 115 or a network entity as described with reference to FIGS. 1 through 16. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1905, the method may include obtaining a data payload for transmission via a message, where the message is generated through a modulation constellation associated with a first quantity of constellation symbols, each of the first quantity of constellation symbols representative of a respective potential bit string of the data payload. The operations of block 1905 may be performed in accordance with examples as disclosed herein. In some examples, aspects of the operations of 1905 may be performed by a payload manager 1425 as described with reference to FIG. 14.

At 1910, the method may include generating a set of multiple bit streams through application of a set of multiple shaping operations to all or part of an actual bit string of the data payload, where one or more of the set of multiple shaping operations are applied to corresponding portions of the actual bit string such that respective bit streams of the set of multiple bit streams are associated with one or more second quantities of constellation symbols of the modulation constellation, where the one or more second quantities are less than the first quantity. The operations of block 1910 may be performed in accordance with examples as disclosed herein. In some examples, aspects of the operations of 1910 may be performed by a bit stream generation manager 1430 as described with reference to FIG. 14.

At 1915, the method may include performing one or more iterations of a first shaping operation and a second shaping operation of the set of multiple shaping operations, each iteration of the one or more iterations corresponding to a respective bit layer of a set of multiple bit layers. The operations of block 1915 may be performed in accordance with examples as disclosed herein. In some examples, aspects of the operations of 1915 may be performed by an iteration manager 1445 as described with reference to FIG. 14.

At 1920, the method may include modulating the actual bit string to a corresponding constellation symbol of the modulation constellation to generate the message. The operations of block 1920 may be performed in accordance with examples as disclosed herein. In some examples, aspects of the operations of 1920 may be performed by a modulation manager 1435 as described with reference to FIG. 14.

At 1925, the method may include transmitting the data payload via the message to a second wireless device. The operations of block 1925 may be performed in accordance with examples as disclosed herein. In some examples, aspects of the operations of 1925 may be performed by a payload manager 1425 as described with reference to FIG. 14.

The following provides an overview of aspects of the present disclosure:
Aspect 1: A method for wireless communications at a first wireless device, comprising: obtaining a data payload for transmission via a message, wherein the message is generated through a modulation constellation associated with a first quantity of constellation symbols, each of the first quantity of constellation symbols representative of a respective potential bit string of the data payload; generating a plurality of bit streams through application of a plurality of shaping operations to all or part of an actual bit string of the data payload, wherein one or more of the plurality of shaping operations are applied to corresponding portions of the actual bit string such that respective bit streams of the plurality of bit streams are associated with one or more second quantities of constellation symbols of the modulation constellation, wherein the one or more second quantities are less than the first quantity; modulating the actual bit string to a corresponding constellation symbol of the modulation constellation to generate the message; and transmitting the data payload via the message to a second wireless device.
Aspect 2: The method of aspect 1, wherein the corresponding constellation symbol of the modulation constellation is indicated by at least a portion of the plurality of bit streams, wherein the plurality of bit streams are organized into groups of bit streams, each group including one bit stream which contributes to the actual bit string of the corresponding constellation symbol of the modulation constellation.
Aspect 3: The method of aspect 2, wherein each group of bit streams corresponds to a respective bit layer having a width of one or more bits on which respective ones of the plurality of shaping operations are applied.
Aspect 4: The method of aspect 3, wherein a first shaping operation of the plurality of shaping operations is applied to a first bit layer of a plurality of bit layers for the first quantity of constellation symbols; and the one or more of the plurality of shaping operations are applied to one or more second bit layers of the plurality of bit layers for the corresponding one or more second quantities of constellation symbols, each bit layer of the plurality of bit layers corresponding to one or more bit levels that correspond to the respective width.
Aspect 5: The method of aspect 4, wherein the first shaping operation is a bit level energy-based shaping operation; and the one or more of the plurality of shaping operations include one or more symbol-level energy-based shaping operations.
Aspect 6: The method of aspect 5, further comprising: inputting the actual bit string to the first shaping operation; and outputting, from the first shaping operation, a first shaped bit stream of the plurality of bit streams.
Aspect 7: The method of any of aspects 5 through 6, further comprising: inputting, to a first of the one or more of the plurality of shaping operations, a first summary of the first shaping operation and a first portion of the actual bit string corresponding to a first of the one or more second bit layers; inputting, to a second of the one or more of the plurality of shaping operations, a second summary of the first shaping operation and a second portion of the actual bit string corresponding to the first of the one or more second bit layers, wherein the first summary and the second summary each pertain to a respective bit value output by the first shaping operation; outputting, from the first of the one or more of the plurality of shaping operations, a second shaped bit stream of the plurality of bit streams; and outputting, from the second of the one or more of the plurality of shaping operations, a third shaped bit stream of the plurality of bit streams, wherein the second shaped bit stream and the third shaped bit stream are both associated with a same bit layer.
Aspect 8: The method of aspect 7, wherein a width of each of the one or more second bit layers corresponds to a quantity of bit levels of a respective one of the one or more second bit layers.
Aspect 9: The method of any of aspects 7 through 8, wherein generating the plurality of bit streams comprises: performing the first of the one or more of the plurality of shaping operations and the second of the one or more of the plurality of shaping operations in parallel.
Aspect 10: The method of any of aspects 1 through 9, wherein one or more of the plurality of shaping operations is based at least in part on a bit-layer shaping parameter comprising a bit-layer sequence composition corresponding to the actual bit string.
Aspect 11: The method of any of aspects 1 through 10, wherein one or more of the plurality of shaping operations is based at least in part on a constant composition distribution matching procedure corresponding to the second quantity of constellation symbols.
Aspect 12: The method of any of aspects 1 through 11, wherein generating the plurality of bit streams comprises: performing one or more iterations of a first shaping operation and a second shaping operation of the plurality of shaping operations, each iteration of the one or more iterations corresponding to a respective bit layer of a plurality of bit layers.
Aspect 13: The method of aspect 12, further comprising: determining a shaping parameter for each iteration of the one or more iterations, the shaping parameter based at least in part on a threshold sequence energy, a bit-bit layer sequence energy parameter value, a decomposed alphabet for the second shaping operation, a threshold sequence length, or any combination thereof.
Aspect 14: The method of any of aspects 12 through 13, further comprising: incrementing an iteration counter after each of the one or more iterations, wherein the modulating is based at least in part on the counter satisfying a threshold quantity of iterations.
Aspect 15: The method of any of aspects 12 through 14, further comprising: inputting, for each limitation of the one or more iterations subsequent to a first iteration of the one or more iterations, a first portion of the actual bit string, the first portion having a sequence length based at least in part on an output sequence of bits of a previous iteration of the one or more iterations.
Aspect 16: The method of any of aspects 12 through 15, further comprising: inputting, for the one or more iterations comprising a single iteration, the actual bit string.
Aspect 17: The method of any of aspects 1 through 16, wherein the modulating comprises: sequentially reading elements from the respective bit streams of the plurality of bit streams based at least in part on an increasing order of bit layers from a first bit layer to a last bit layer of a plurality of bit layers.
Aspect 18: An apparatus for wireless communications at a first wireless device, comprising at least one processor; at least one memory coupled with the at least one processor; and instructions stored in the at least one memory and executable by the at least one processor to cause the apparatus to perform a method of any of aspects 1 through 17.
Aspect 19: An apparatus for wireless communications at a first wireless device, comprising at least one means for performing a method of any of aspects 1 through 17.
Aspect 20: A non-transitory computer-readable medium storing code for wireless communications at a first wireless device, the code comprising instructions executable by a processor to perform a method of any of aspects 1 through 17.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), (e.g., Institute of Electrical and Electronics Engineers (IEEE) 802.11) (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., including a list of items prefaced by a phrase such as “at least one of” or “one or more of”) indicates an inclusive list such that, for example, a list of at least one of A, B, or C means, e.g., A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communications at a first wireless device, comprising:
at least one processor; and
at least one memory coupled with the at least one processor, the at least one memory storing instructions executable by the at least one processor to cause the first wireless device to:
obtain a data payload for transmission via a message, wherein the message is generated through a modulation constellation associated with a first quantity of constellation symbols, each of the first quantity of constellation symbols representative of a respective potential bit string of the data payload;
generate a plurality of bit streams through application of a plurality of shaping operations to all or part of an actual bit string of the data payload, wherein one or more of the plurality of shaping operations are applied to corresponding portions of the actual bit string such that respective bit streams of the plurality of bit streams are associated with one or more second quantities of constellation symbols of the modulation constellation, wherein the one or more second quantities are less than the first quantity;
modulate the actual bit string, from the plurality of bit streams, to a corresponding constellation symbol of the modulation constellation to generate the message; and
transmit the data payload via the message to a second wireless device.

2. The apparatus of claim 1, wherein the corresponding constellation symbol of the modulation constellation is indicated by at least a portion of the plurality of bit streams, wherein the plurality of bit streams are organized into groups of bit streams, each group including one bit stream which contributes to the actual bit string of the corresponding constellation symbol of the modulation constellation.

3. The apparatus of claim 2, wherein each group of bit streams corresponds to a respective bit layer having a width of one or more bits on which respective ones of the plurality of shaping operations are applied.

4. The apparatus of claim 3, wherein:
a first shaping operation of the plurality of shaping operations is applied to a first bit layer of a plurality of bit layers for the first quantity of constellation symbols; and
the one or more of the plurality of shaping operations are applied to one or more second bit layers of the plurality of bit layers for the corresponding one or more second quantities of constellation symbols, each bit layer of the plurality of bit layers corresponding to one or more bit levels that correspond to the respective width.

5. The apparatus of claim 4, wherein:
the first shaping operation is a bit level energy-based shaping operation; and
the one or more of the plurality of shaping operations include one or more symbol-level energy-based shaping operations.

6. The apparatus of claim 5, wherein the instructions are further executable by the at least one processor to cause the apparatus to:
input the actual bit string to the first shaping operation; and
outputting, from the first shaping operation, a first shape bit stream of the plurality of bit streams.

7. The apparatus of claim 5, wherein the instructions are further executable by the at least one processor to cause the apparatus to:
input, to a first of the one or more of the plurality of shaping operations, a first summary of the first shaping operation and a first portion of the actual bit string corresponding to a first of the one or more second bit layers;
input, to a second of the one or more of the plurality of shaping operations, a second summary of the first shaping operation and a second portion of the actual bit string corresponding to the first of the one or more second bit layers, wherein the first summary and the second summary each pertain to a respective bit value output by the first shaping operation;
outputting, from the first of the one or more of the plurality of shape operations, a second shaped bit stream of the plurality of bit streams; and
outputting, from the second of the one or more of the plurality of shape operations, a third shaped bit stream of the plurality of bit streams, wherein the second shaped bit stream and the third shaped bit stream are both associated with a same bit layer.

8. The apparatus of claim 7, wherein a width of each of the one or more second bit layers corresponds to a quantity of bit levels of a respective one of the one or more second bit layers.

9. The apparatus of claim 7, wherein the instructions to generate the plurality of bit streams are executable by the at least one processor to cause the apparatus to:
perform the first of the one or more of the plurality of shaping operations and the second of the one or more of the plurality of shaping operations in parallel.

10. The apparatus of claim 1, wherein one or more of the plurality of shaping operations is based at least in part on a bit layer shaping parameter comprising a bit layer sequence composition corresponding to the actual bit string.

11. The apparatus of claim 1, wherein one or more of the plurality of shaping operations is based at least in part on a constant composition distribution matching procedure corresponding to the second quantity of constellation symbols.

12. The apparatus of claim 1, wherein the instructions to generate the plurality of bit streams are executable by the at least one processor to cause the apparatus to:
perform one or more iterations of a first shaping operation and a second shaping operation of the plurality of shaping operations, each iteration of the one or more iterations corresponding to a respective bit layer of a plurality of bit layers.

13. The apparatus of claim 12, wherein the instructions are further executable by the at least one processor to cause the apparatus to:
determine a shaping parameter for each iteration of the one or more iterations, the shaping parameter based at least in part on a threshold sequence energy, a bit-bit layer sequence energy parameter value, a decomposed alphabet for the second shaping operation, a threshold sequence length, or any combination thereof.

14. The apparatus of claim 12, wherein the instructions are further executable by the at least one processor to cause the apparatus to:
increment an iteration counter after each of the one or more iterations, wherein the modulating is based at least in part on the counter satisfying a threshold quantity of iterations.

15. The apparatus of claim 12, wherein the instructions are further executable by the at least one processor to cause the apparatus to:
input, for each iteration of the one or more iterations subsequent to a first iteration of the one or more iterations, a first portion of the actual bit string, the first portion having a sequence length based at least in part on an output sequence of bits of a previous iteration of the one or more iterations.

16. The apparatus of claim 12, wherein the instructions are further executable by the at least one processor to cause the apparatus to:
input, for the one or more iterations comprising a single iteration, the actual bit string.

17. The apparatus of claim 1, wherein the instructions to modulating are executable by the at least one processor to cause the apparatus to:
sequentially read elements from the respective bit streams of the plurality of bit streams based at least in part on an increasing order of bit layers from a first bit layer to a last bit layer of a plurality of bit layers.

18. A method for wireless communications at a first wireless device, comprising:
obtaining a data payload for transmission via a message, wherein the message is generated through a modulation constellation associated with a first quantity of constellation symbols, each of the first quantity of constellation symbols representative of a respective potential bit string of the data payload;
generating a plurality of bit streams through application of a plurality of shaping operations to all or part of an actual bit string of the data payload, wherein one or more of the plurality of shaping operations are applied to corresponding portions of the actual bit string such that respective bit streams of the plurality of bit streams are associated with one or more second quantities of constellation symbols of the modulation constellation, wherein the one or more second quantities are less than the first quantity;
modulating the actual bit string, from the plurality of bit streams, to a corresponding constellation symbol of the modulation constellation to generate the message; and
transmitting the data payload via the message to a second wireless device.

19. The method of claim 18, wherein the corresponding constellation symbol of the modulation constellation is indicated by at least a portion of the plurality of bit streams, wherein the plurality of bit streams are organized into groups of bit streams, each group including one bit stream which contributes to the actual bit string of the corresponding constellation symbol of the modulation constellation.

20.-28. (canceled)

29. An apparatus for wireless communications at a first wireless device, comprising:
means for obtaining a data payload for transmission via a message, wherein the message is generated through a modulation constellation associated with a first quantity of constellation symbols, each of the first quantity of constellation symbols representative of a respective potential bit string of the data payload;
means for generating a plurality of bit streams through application of a plurality of shaping operations to all or part of an actual bit string of the data payload, wherein one or more of the plurality of shaping operations are applied to corresponding portions of the actual bit string such that respective bit streams of the plurality of bit streams are associated with one or more second quantities of constellation symbols of the modulation constellation, wherein the one or more second quantities are less than the first quantity;
means for modulating the actual bit string, from the plurality of bit streams, to a corresponding constellation symbol of the modulation constellation to generate the message; and
means for transmitting the data payload via the message to a second wireless device.

30. (canceled)
